(19) United States
(12) Patent Application Publication
(10) Pub. No.: US 2026/0333276 A1
(43) Pub. Date: Oct. 22, 2026

(54) METHODS AND APPARATUS FOR RESOURCE SELECTION AND CONGESTION CONTROL FOR SL-PRS

(71) Applicant: INTERDIGITAL PATENT HOLDINGS, INC., Wilmington, DE (US)

(72) Inventors: Tuong Hoang, Montreal (CA); Fumihiro Hasegawa, Westmount (CA); Tao Deng, New York, NY (US); Jaya Rao, Montreal (CA); Kunjan Shah, London (GB); Paul Marinier, Brossard (CA); Moon IL Lee, Melville, NY (US)

(73) Assignee: INTERDIGITAL PATENT HOLDINGS, INC., Wilmington, DE (US)

(21) Appl. No.: 19/101,472

(22) PCT Filed: Aug. 4, 2023
(86) PCT No.: PCT/US2023/029525

§ 371 Date: Feb. 5, 2025

Related U.S. Application Data
(60) Provisional application No. 63/395,551, filed on Aug. 5, 2022.
(60) Provisional application No. 63/421,810, filed on Nov. 2, 2022.
(60) Provisional application No. 63/445,549, filed on Feb. 14, 2023.

(51) Int. Cl. H04W 64/00; H04W 72/25

(52) U.S. Cl. CPC H04W 64/00; H04W 72/25

(57) ABSTRACT

A wireless transmit/receive unit (WTRU) may receive information that indicates a sidelink positioning reference signal (SL-PRS) priority threshold and may receive information that triggers a SL-PRS transmission that has an associated priority. The WTRU may determine a first type of SL-PRS resources and a second type of SL-PRS resources based on sensing during a sensing window. The first type of SL-PRS resources may be resources that are not multiplexed with other WTRUs. The second type of SL-PRS resources may be resources that are multiplexed with other WTRUs. The WTRU may select, based on the priority associated with the SL-PRS transmission and the SL-PRS priority threshold, available resources to include in a SL-PRS candidate resource set. The WTRU may select one or more SL-PRS resources from the SL-PRS candidate resource set. The WTRU may transmit a SL-PRS in the selected one or more SL-PRS resources.

### CROSS-REFERENCE TO RELATED APPLICATIONS

This application claims the benefit of U.S. Provisional Application No. 63/445,549, filed Feb. 14, 2023, U.S. Provisional Application No. 63/421,810, filed Nov. 2, 2022, and U.S. Provisional Application No. 63/395,551, filed Aug. 5, 2022, the contents of which are incorporated herein by reference.

### BACKGROUND

NR vehicular communications (V2X) was designed to support sidelink communication among different vehicles. In NR V2X, the resource for sidelink transmission/reception is structured as resource pools. A resource pool comprises a set of continuous frequency resources repeating in time following a bitmap pattern. A wireless transmit/receive unit (WTRU) may be configured with one or multiple resource pools. For in coverage WTRUs, the resource pool(s) may be configured via a system information block (SIB) or radio resource control (RRC) signaling. For out of coverage WTRUs, the resource pool(s) may be (pre-)configured.

### SUMMARY

A wireless transmit/receive unit (WTRU) may receive information that indicates a sidelink positioning reference signal (SL-PRS) priority threshold. The WTRU may receive information that triggers a SL-PRS transmission that has an associated priority. The WTRU may determine a first type of SL-PRS resources and a second type of SL-PRS resources based on sensing during a sensing window. The first type of SL-PRS resources may be resources that are not multiplexed with other WTRUs. The second type of SL-PRS resources may be resources that are multiplexed with other WTRUs. The WTRU may select, based on the priority associated with the SL-PRS transmission and the SL-PRS priority threshold, available resources to include in a SL-PRS candidate resource set. The SL-PRS candidate resource set may include at least the first type of SL-PRS resources or the second type of SL-PRS resources. The WTRU may select one or more SL-PRS resources from the SL-PRS candidate resource set. The WTRU may transmit a SL-PRS in the selected one or more SL-PRS resources. The WTRU may determine SL-PRS resources that are reserved by other WTRUS. The WTRU may select available resources from both the first type of SL-PRS resources and the second type of SL-PRS resources on a condition that the priority associated with the SL-PRS transmission is lower than the SL-PRS priority threshold. The WTRU may select available resources from only the first type of SL-PRS resources on a condition that the priority associated with the SL-PRS transmission is higher than or equal to the SL-PRS priority threshold. The first type of SL-PRS resources may be resources that are not resource element (RE) level multiplexed with other WTRUs. The second type of SL-PRS resources may be resources that are resource element (RE) level multiplexed with other WTRUs. The information that triggers a SL-PRS transmission may be received from a higher layer in the WTRU. The information that triggers a SL-PRS transmission may be received from a non-access stratum (NAS) layer. The WTRU may the select available resources to include in a SL-PRS candidate resource set during a resource selection window (RSW). The WTRU may transmit a sidelink control information (SCI) that indicates SL-PRS information. The SL-PRS information may indicate a SL-PRS pattern.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 shows an example of a number of consecutive PSSCH symbols for potential SL-PRS transmission;

FIG. 3 shows an example of how a WTRU determines different type of available resources for SL-PRS transmission;

FIG. 4 shows an example of a WTRU prioritizing selection of a resource without multiplexing and without overlapping with other transmission;

FIG. 5 shows an example of a WTRU determining the availability of each SL-PRS pattern based on a detection of a reserved pattern;

FIG. 6 shows examples of SL-PRS structures in a dedicated resource pool for SL-PRS;

FIG. 7 shows an example of a WTRU filling remaining symbols of a mini-slot for SL-PRS;

FIG. 8 shows an example of a WTRU (UE) triggering resource reselection upon detection of a change in the associated periodic SL-PRS process from a peer WTRU (UE);

FIG. 9 shows an example method for resource allocation in a dedicated resource pool for SL-PRS;

FIG. 10 shows an example method for resource allocation in a shared resource pool between SL-PRS and sidelink data;

FIG. 11 shows an example method for congestion control in a dedicated resource pool for SL-PRS;

FIG. 12 show an example method for congestion control in a shared resource pool between SL-PRS and sidelink data communication;

FIG. 13 shows an example method for determining an SCI to indicate SL-PRS information;

FIG. 14 shows an example of sensing to determine a first and second type of SL-PRS resources; and

FIG. 15 shows an example method for determining SL-PRS candidate resource sets based on priority.

### DETAILED DESCRIPTION

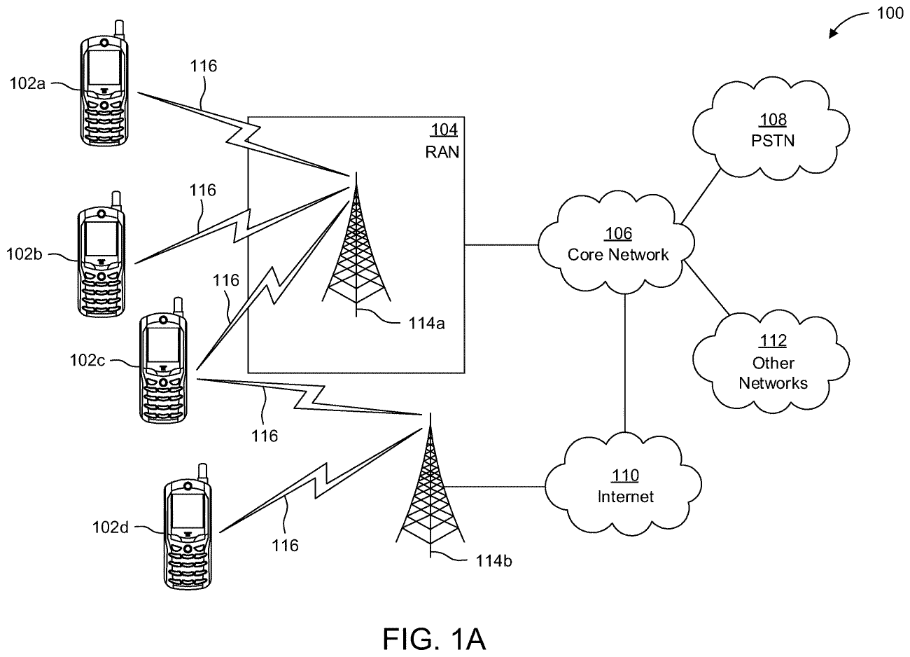

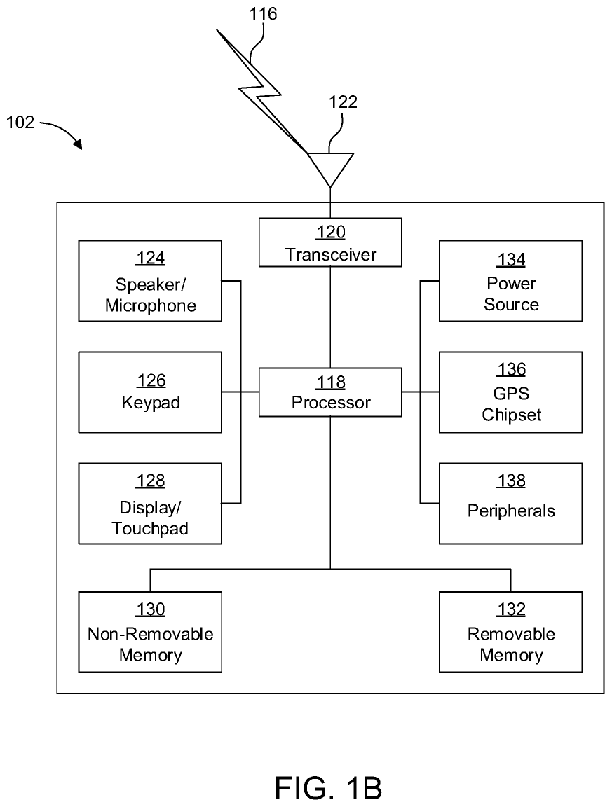

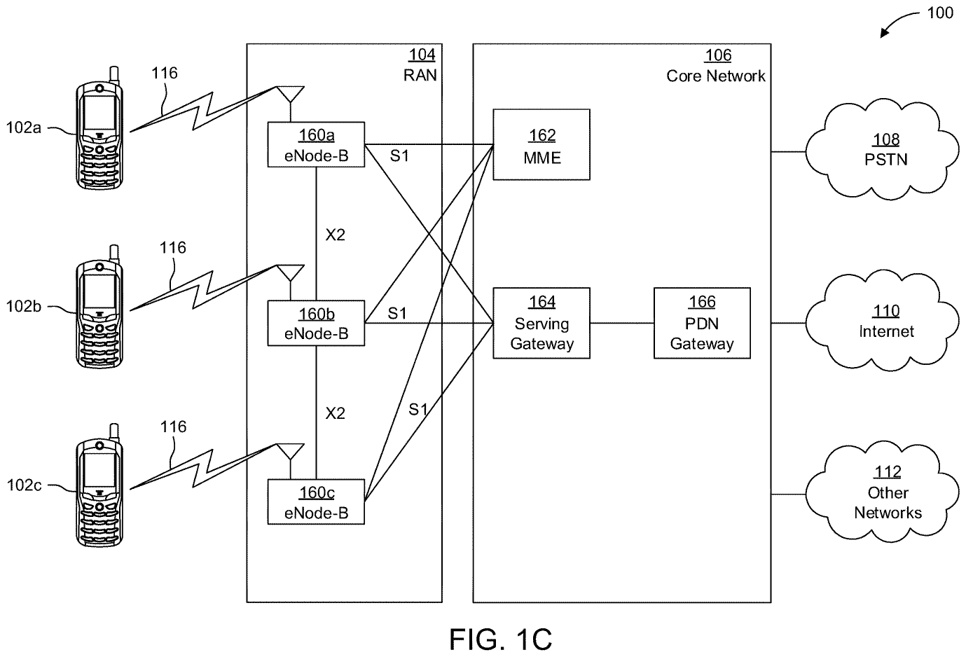

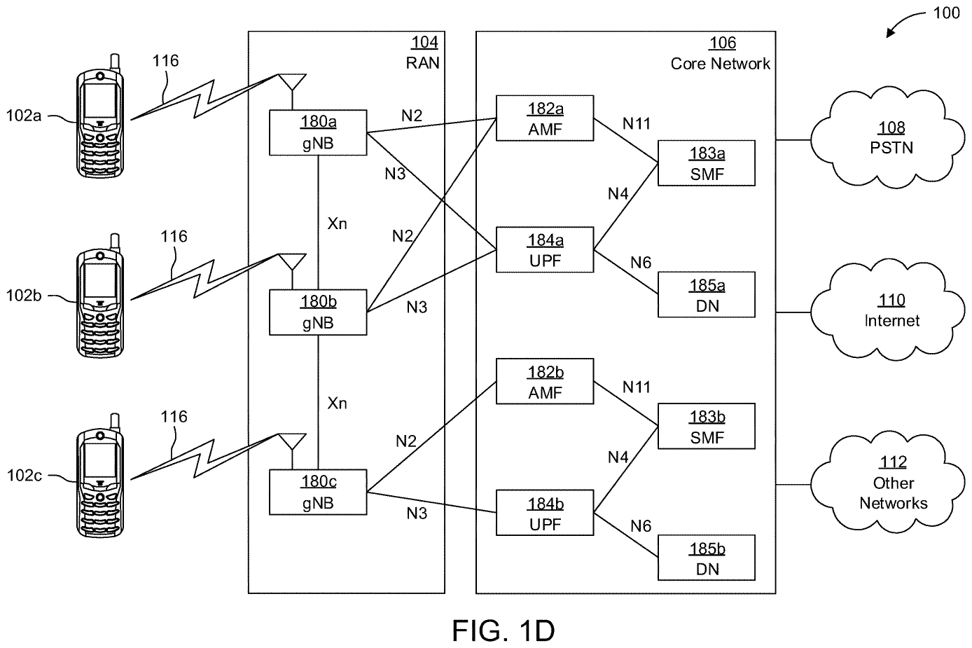

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA20001X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUS 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114 b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QOS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Each sidelink transmission spans within one slot comprising a physical sidelink shared channel (PSSCH) and physical sidelink control channel (PSCCH). PSSCH and PSCCH are frequency division multiplexing (FDM) and time division multiplexing (TDM) multiplexed. Sidelink control information (SCI) is divided into two parts which are the first stage SCI and the second stage SCI. A first stage SCI indicates the resources used for sidelink transmission, the QoS of the transmission (e.g., priority), demodulation reference signal (DMRS), phase tracking reference signal (PTRS) used for the sidelink transmission and a second SCI format. The second stage SCI indicates the remaining control information. SCI may be used to reserve the resources for future transmission within a resource pool.

From a sidelink scheduling perspective, the sidelink resources may be scheduled by the network (i.e., Mode 1) or autonomously selected by a WTRU (i.e., Mode 2). If the WTRU performs Mode 2, it may perform sensing by decoding an SCI from other WTRUs before selecting the sidelink resources to avoid selecting the resources reserved by other WTRUs. For WTRU autonomous resource allocation (i.e., Mode 2), we specify how the WTRU performs sensing and performs resource selection for sidelink data communication. For example, the WTRU is (pre-)configured with a resource pool for sensing and resource allocation. The WTRU performs sensing during a sensing window to detect transmissions and resource reservation from other WTRUs (e.g., via SCI decoding). Then, upon data arrival, the WTRU triggers resource selection to select the resources for its transmission. The WTRU selects a resource selection window (RSW) as a function of a packet delay budget (PDB). In the RSW, the WTRU first determines which resources are reserved by another WTRU and excludes it from the set of selectable resources. The WTRU then selects the resources for transmission in the RSW from the set of selectable resources. The WTRU may select the resources for periodic and aperiodic transmission.

Sidelink channel state information reference signal (SL-CSI-RS) is supported for unicast communication to support a transmitting WTRU in determining transmission parameters (e.g., power and rank). A transmitting WTRU may indicate the presence of SL-CSI-RS by using a SCI. CSI-RS transmission may trigger CSI reporting. CSI reporting latency may be configured via, for example PC5 RRC. Each reporting is associated with one SL-CSI-RS transmission.

Congestion control is designed to help the network manage the resource pool's usage to guarantee a proper resource usage of different WTRUs. Two parameters are defined for congestion control: Channel Busy Ratio (CBR) and Channel Occupancy Ratio (CR). CBR indicates the ratio between the number of busy subchannels and the total number of subchannels in a duration. CR indicates the number of resources used by the WTRU in a duration.

For congestion control, the following parameters are controlled based on the congestion level of a resource pool: transmission power, bandwidth, modulation and coding scheme (MCS); a number of transmission for one transport block (TB), and CR.

NR Uu positioning specifies downlink (DL)-based, uplink (UL)-based, and DL+UL-based positioning methods.

In a DL-based positioning method, a DL-positioning reference signal (PRS) may be sent from multiple transmission and reception point (TRP)s to a WTRU. The WTRU may observe measured downlink signals from the TRPs. A WTRU may be (pre)configured to perform a WTRU-based positioning method (WTRU-B) and/or a WTRU-Assisted positioning method (WTRU-A). For the WTRU-B method, the WTRU may calculate or determine its position and for a WTRU-A method, the WTRU may return the downlink measurement to the network. For an Angle-based method, the WTRU may report the angle of arrival (AoA) and a reference signal receive power (RSRP) of the downlink signals from the TRPs. For a timing-based method, the WTRU may report a reference signal time difference (RSTD). The above methods require the transmission timing synchronization among the TRPs. The positioning calculation errors mostly comes from synchronization error and multipath.

In UL-based positioning methods, the WTRU may send UL-PRS for positioning, configured by RRC, to the TRP. The network may then calculate the position of the WTRU based on the coordination of all the TRPs receiving an UL-PRS from the WTRU.

In the UL and DL-based methods, the WTRU may measure a Rx-Tx time difference between a received DL-PRS and an UL-PRS transmitted. The Rx-Tx time difference and RSRP are reported to the network. The network may then coordinate the TRPs to calculate the position of the WTRU.

Examples of sidelink SL positioning method include a timing/angle positioning method and a round trip time (RTT) positioning method.

A timing/angle positioning method may refer to any positioning method that uses reference signals such as a SL-PRS. A WTRU may receive multiple reference signals from WTRU(s) and measure for example, RSTD, RSRP, and/or AoA. Examples of angle/timing positioning methods are SL-angle of departure (AoD) or SL-time distance of arrival (TDOA) positioning. In an example, the may WTRU transmit a SL-PRS to WTRU(s) and a receiver performs measurements (e.g., RSTD, AoA, RSRP) for determination of the location of the WTRU which transmitted the SL-PRS.

A RTT positioning method may refer to any positioning method that requires two WTRUs to transmit a SL-PRS to each other. In an example, an anchor WTRU may transmit a SL-PRS to a target WTRU. Once the target WTRU receives the SL-PRS from the anchor WTRU, the target WTRU may transmit a SL-PRS to the anchor WTRU. The target WTRU may measure a WTRU Tx-Rx time difference which is the difference between transmission time of the SL PRS from the target WTRU and reception time of the SL-PRS transmitted from the anchor WTRU. The target WTRU may report the WTRU Tx-Rx time difference to the anchor WTRU.

An absolute position of a WTRU may be expressed in terms of Geographical Coordinate System (GCS) or Local Coordinate System (LCS).

A relative position of a target WTRU may be expressed in terms of distance and/or angle from another WTRU(s) (e.g., anchor WTRU(s) and/or a reference point with a known location.

A SL-PRS configuration may include at least one of the following: SL-PRS resource identification (ID); SL-PRS sequence ID, or other IDs used to generate a SL-PRS sequence; SL-PRS resource element offset; SL-PRS resource slot offset; SL-PRS symbol offset; SL-PRS quasi colocation (QCL) information; SL-PRS resource set ID; list of SL-PRS resources in the resource set; number of SL-PRS symbols; muting pattern for SL-PRS, muting parameters such as repetition factor, muting options; SL-PRS resource power; periodicity of SL-PRS transmission; spatial direction information of SL-PRS transmission (e.g., beam information, angles of transmission); spatial direction information of SL-RS reception (e.g., beam ID used to receive SL-RS, angle of arrival); frequency layer ID; WTRU ID; or SL-PRS ID.

For sidelink positioning, it is expected that a sidelink positioning reference signal (SL-PRS) used to determine a location of the WTRUs in sidelink may use a shared resource pool with normal sidelink data or a dedicated resource pool for reference signal transmission only.

In positioning, a QoS of a positioning service (e.g., priority, accuracy, latency, availability, and reliability) of the positioning depends on the quality of SL-PRS transmission/reception, which may be much different from the QoS of normal data transmissions. It is expected that different QoS parameters may require different SL-PRS transmission/reception characteristics. For resource allocation, in a shared resource pool, it is necessary to design a resource allocation scheme to reduce collisions between different SL-PRS and between SL-PRS and normal data considering different collision level tolerances between SL-PRS and data. In a dedicated resource pool, a resource allocation scheme to mitigate collision between SL-PRS transmission needs to be considered. Finally, if many WTRUs are using SL-PRS, congestion may happen, so a method to control the congestion in a resource pool needs to be considered. There is a need to determine how a WTRU performs resource allocation and congestion control for SL-PRS in a shared and dedicated resource pool.

In an embodiment, a resource allocation (RA) in a dedicated resource pool is considered. A WTRU (e.g., target WTRU) may determine which set of available resources for a SL-PRS transmission to select based on the number of available resources in each set. The WTRU (e.g., target WTRU) may perform the following procedure for resource allocation in a dedicated resource pool for SL-PRS. The WTRU may be (pre-)configured with a dedicated resource pool for SL-PRS transmission. The WTRU may be (pre-)configured with a threshold of X % and Y % of a first and second type of resources, respectively to perform SL-PRS selection, in which X % and Y % is the function of the QoS of the positioning service (e.g., priority, accuracy, latency, availability, and/or reliability). For example, the first set of resources may include the set of slots for SL-PRS transmission, and the second set of resources may include the set of SL-PRS patterns for SL-PRS transmission. The WTRU may receive the QoS information of the positioning service and the SL-PRS pattern to select from another node (e.g., anchor WTRU). The WTRU may determine the value of X and Y based on the QoS received from the other node. The WTRU may perform sensing, by decoding a SCI, to determine the first and second set of available resources. The WTRU may perform the following to select a SL-PRS resources for transmission: If the first set of resource is greater than X %, the WTRU may select a SL-PRS resource from the first set, otherwise, if the second set of resources is greater than Y %, the WTRU may select a SL-PRS resource from the second set. If SL-PRS resources are selected, the WTRU may transmit the SL-PRSs in the set of selected resources. Otherwise, the WTRU may request the other node (e.g., anchor WTRU) to change the SL-PRS pattern. In an embodiment, a RA in a shared resource pool is considered. A WTRU may determine which RSRP threshold to apply to determine the availability of each reserved resource based on whether the resource is reserved for a normal data communication or a SL-PRS. In case the number of available resources is smaller than a threshold, the WTRU may request another WTRU to change the SL-PRS pattern. The WTRU (e.g., target WTRU) may perform the following procedure for resource allocation in a shared resource pool between SL-PRS and sidelink communication. The WTRU may be (pre-)configured with a shared resource pool for SL-PRS and data communication and a threshold of X % of available resources for SL-PRS selection. The WTRU may be (pre-)configured with two set of RSRP thresholds. One set RSRP thresholds may be applied for SL-PRS resources and the other set of RSRP thresholds may be applied for data transmission. The WTRU may receive the QoS information of the positioning service and the SL-PRS pattern to select from another node (e.g., anchor WTRU). The WTRU may perform sensing by decoding a SCI, which is used to reserve transmission resources, from other WTRUs. For each reserved resource, the WTRU may determine whether the reserved resource is for SL-PRS or normal data communication. The WTRU may determine the set of available resources for SL-PRS transmission using the first set of RSRP thresholds and the second set of RSRP thresholds, in which the WTRU may apply the first set of thresholds to resources associated with SL-PRS and the WTRU may apply the second set of thresholds to resources associated with data communication. The WTRU may perform the following for SL-PRS selection: If the number of available resources is greater than X %, the WTRU may select resources for SL-PRS using the subset of available resources and indicate in the SCI that the resource is reserved for SL-PRS transmission, otherwise, the WTRU may request the other node to change the SL-PRS pattern (e.g., anchor WTRU) or switch to another resource pool for SL-PRS selection.

In an embodiment, congestion control in a dedicated resource pool is considered. A WTRU may determine a first set of transmission (Tx) parameters for SL-PRS based on a first QoS parameter of the positioning service and a second set of Tx parameters for SL-PRS based on a second QoS parameter. The WTRU may perform the following procedure for congestion control in a dedicated resource pool for SL-PRS. The WTRU may be (pre-)configured with a dedicated resource pool for SL-PRS. The WTRU may be (pre-)configured with two sets of Tx parameter thresholds as a function of CBR, in which the first set is associated with the first positioning QoS parameter, and the second set is associated with the second positioning QoS parameter. For example, the maximum bandwidth may be a function of the accuracy/priority requirement and the number of SL-PRS transmission within a period may be a function of the latency requirement. The WTRU may determine the Tx parameters based on both QoS values, CBR, and the associated Tx parameters thresholds. The WTRU may perform SL-PRS transmission based on the determined transmission parameters.

In an embodiment, congestion control in a shared resource pool is considered. A WTRU may determine which set of Tx parameters to use based on whether a SL-PRS is multiplexed with data or not. The WRU may use a first set of Tx parameters for standalone SL-PRS and both a first and second set of parameters for SL-PRS multiplexing with data. The WTRU may perform the following procedure for congestion control in a shared resource pool between SL-PRS and sidelink communication. The WTRU may be (pre-)configured with a shared resource pool for SL-PRS and data communication. The WTRU may be (pre-)configured with two sets of Tx parameters as a function of CBR, in which the first set may be used for SL-PRS transmission (e.g., Tx power, bandwidth, CR limit for SL-PRS, comb-N, number of symbols, etc.) and the second set may be used for data transmission. The WTRU may determine the Tx parameters for a SL-PRS based on whether it is standalone SL-PRS or SL-PRS multiplexing with sidelink data. For standalone SL-PRS, the WTRU may apply the first set of Tx parameters. For SL-PRS multiplexing with sidelink data, the WTRU may determine the Tx parameters based on both the first and the second set of Tx parameters threshold (e.g., each Tx parameters needs to satisfy either threshold in the first or second set). The WTRU may perform SL-PRS transmission based on the determined transmission parameters.

A WTRU may determine signals for SL-PRS. A WTRU may use one or any of the following reference signals as a SL-PRS: DMRS of PSSCH and/or PSCCH; sidelink synchronization signal (SLSS) (e.g. sidelink primary synchronization signal (S-PSS), sidelink secondary synchronization signal (S-SSS)), phase tracking reference signal (PTRS); SL-CSI-RS; physical sidelink feedback channel (PSFCH); or a new reference signal (RS) designed for positioning purposes.

In an embodiment, a WTRU may determine the QoS of the positioning service. The QoS of the positioning service may be used to determine one or more of: priority, accuracy, latency, reliability, minimum communication range (MCR), and/or positioning availability requirements of the positioning service. The QoS of the positioning service may be determined based on one or any combination of the following.

The QoS of the positioning service may be determined based on a (pre-)configuration in the resource pool and/or the WTRU. For example, in a shared resource pool between SL-PRS and sidelink data communication, the WTRU may be (pre-)configured with a priority associated with SL-PRS transmission. The WTRU may indicate the (pre-)configured priority of the sidelink positioning service in one or more transmissions associated with the SL-PRS transmission.

The QoS of the positioning service may be determined based on one or more parameters of SL-PRS transmission and/or reception. For example, the WTRU may determine the QoS of the positioning service (e.g., accuracy/priority) based on a bandwidth of the SL-PRS. For example, the WTRU may be (pre-)configured with one or more QoS levels of the positioning service. Each QOS level may be associated with a bandwidth of SL-PRS. The WTRU may determine the QoS of the positioning service based on the bandwidth of SL-PRS transmission/reception.

The QoS of the positioning service may be determined based on SL-PRS reception requirements (e.g., the minimum received SL-RSRP, or the maximum reception timing error). For example, the WTRU may determine one or more QoS of the positioning service (e.g., accuracy/priority) based on the SL-RSRP reception requirement of SL-PRS. For example, the WTRU may be (pre-)configured with one or more QoS levels of the positioning service, in which each QoS level may be associated with a SL-RSRP reception level of SL-PRS. The WTRU may determine the QoS of the positioning service based on the required SL-PRSP level of SL-PRS.

The QoS of the positioning service may be determined based on an implicit/explicit indication from another node (e.g., another WTRU or gNB). For example, the WTRU may implicitly/explicitly receive one or more QoS parameters of the positioning service from another WTRU or gNB. The WTRU may receive one or more QoS parameters based on the reception of the SL-PRS configuration (e.g., priority, bandwidth, comb size, number of repetitions, periodicity), and SL-PRS measurement report configuration (e.g., priority, periodicity, latency).

The QoS of the positioning service may be determined based on one or more parameters of the DL-PRS reception and/or UL-PRS transmission (pre-)configured or conveyed to the WTRU. For example, for hybrid sidelink and Uu positioning, the WTRU may determine the QoS of the positioning service (e.g., accuracy/priority) based on the bandwidth of the UL-PRS and/or DL-PRS. For example, the WTRU may be (pre-)configured with one or more QoS levels of the positioning service. Each QoS level may be associated with a bandwidth of UL-PRS and/or DL-PRS. The WTRU may determine the QoS of the positioning service based on the bandwidth of SL-PRS transmission/reception.

The QoS of the positioning service may be determined based on one or more parameters of a SL-PRS measurement report (e.g., priority, latency, periodicity).

The QoS of the positioning service may be determined based on one or more parameters for a DL-PRS measurement report (e.g., priority, latency, periodicity).

The QoS of the positioning service may be determined based on the positioning method. For example, the WTRU may be (pre-)configured with one or more QOS parameters associated with the positioning method. For example, the WTRU may be (pre-)configured with a priority associated with each positioning method.

A WTRU may determine the priority of SL-PRS based on a cast type of the SL-PRS. In an embodiment, the WTRU may determine the priority of SL-PRS based on the cast type associated with the SL-PRS (e.g. unicast, groupcast, or broadcast). In an example, the WTRU may be (pre-)configured with three priority in which each priority may be associated with a cast type. The WTRU may determine the priority of the SL-PRS based on its cast type. In an example, the WTRU may be (pre-)configured with different priority offsets, and each priority offset may be associated with a cast type of SL-PRS. The WTRU may determine the priority of the SL-PRS based on other factors (e.g. accuracy, latency, etc.) and the cast type of the SL-PRS.

A WTRU may prioritize among SL-PRS from different cast types. In an embodiment, a WTRU may need to prioritize SL-PRS transmission and/or reception of different cast types. The WTRU may determine to prioritize which SL-PRS based on a (pre-)configured precedence cast type of the SL-PRS. For example, the WTRU may first prioritize broadcast SL-PRS. The WTRU may then prioritize groupcast SL-PRS and finally unicast SL-PRS may not be prioritized.

A WTRU may indicate the QoS parameters for a sidelink positioning service in its transmission The WTRU may indicate one or any combination of the QoS parameters of the sidelink positioning service in one or more of its transmission. For example, the WTRU may indicate one or more parameters of the QoS of the positioning service in the SCI of the associated transmission with the SL-PRS.

A WTRU may determine the resource pool for SL-PRS transmission. In an embodiment, A WTRU may be (pre-)configured with one or any combination of the following resource pools for SL-PRS transmission: a dedicated resource pool for SL-PRS transmission; a dedicated resource pool for transmission and/or reception of SL-PRS configuration; a shared resource pool for SL-PRS and sidelink communication; and a dedicated resource pool for sidelink positioning transmission, which may include one or more of the following: SL-PRS transmission, HARQ feedback for SL-PRS transmission, sidelink positioning assistant information, and sidelink positioning measurement reporting.

The WTRU may determine which resource pool to use for SL-PRS transmission based on one or any combination of the following.

The WTRU may determine which resource pool to use for SL-PRS transmission based on whether the dedicated resource pool for SL-PRS or sidelink positioning is (pre-)configured. For example, the WTRU may prioritize a dedicated resource pool for SL-PRS or sidelink positioning if the dedicated resource pool is (pre-)configured. Otherwise, if a dedicated resource pool is not configured, the WTRU may select a shared resource pool for SL-PRS transmission.

The WTRU may determine which resource pool to use for SL-PRS transmission based on a QoS of the positioning service (e.g., priority, accuracy, latency, and/or positioning availability). For example, the WTRU may determine which resource pool to use based on the QoS of the resource pool. For example, the WTRU may determine to use a dedicated resource pool for SL-PRS or sidelink positioning if the accuracy/priority requirement of the positioning service is greater than a threshold. Otherwise, if the accuracy/priority requirement of the positioning service is smaller than the threshold, the WTRU may use a shared resource pool with sidelink data communication. In an example, the WTRU may be (pre-)configured with a certain QoS (e.g., certain accuracy/priority requirement) to use one resource pool for SL-PRS (e.g., a dedicated resource pool for SL-PRS). The WTRU may then use the resource pool (e.g., dedicated resource pool) for SL-PRS transmission if its required QoS satisfies the (pre-)configured QoS threshold. Otherwise, the WTRU may use another resource pool (e.g., shared resource pool) for SL-PRS transmission.

The WTRU may determine which resource pool to use for SL-PRS transmission based on SL-PRS transmission pattern. For example, the WTRU may determine the SL-PRS transmission pattern. The WTRU may determine which type of resource pool to transmit the selected SL-PRS transmission pattern based on whether the SL-PRS pattern is supported in the resource pool. The WTRU may determine to use the first type of resource pool (e.g., a dedicated resource pool) for the first SL-PRS pattern. The WTRU may determine to use the second type of resource pool for the second SL-PRS pattern.

The WTRU may determine which resource pool to use for SL-PRS transmission based on a type of SL-PRS transmission. For example, the WTRU may use a first type of resource pool for periodic SL-PRS transmission (e.g., dedicated resource pool). The WTRU may a the second type of resource pool (e.g., shared resource pool) for aperiodic SL-PRS transmission.

The WTRU may determine which resource pool to use for SL-PRS transmission based on a sidelink condition between the WTRU and one or more receiver WTRUs. The sidelink condition between the transmitter and receiver WTRUs may be determined based on one or any combination of the distance between two WTRUs and a channel condition (e.g., SL-RSRP measured in the SL-PRS and/or data communication between two WTRUs, pathloss of the channel between two WTRUs). For example, the WTRU may use one resource pool (e.g., a dedicated resource pool for SL-PRS or sidelink positioning) if the distance between two WTRUs (e.g., may be determined based on a zone ID of the Tx and/or Rx WTRUs) is larger than a threshold. Otherwise, the WTRU may use another resource pool (e.g., shared resource pool), if, for example, the distance between two WTRUs is smaller than the threshold. The distance threshold may be (pre-)configured in the resource pool and/or indicated to the WTRU from another node (e.g., gNB or another WTRU). The distance threshold may be (pre-)configured as a function of the QoS of the positioning service (e.g., the accuracy/priority requirement of the positioning service). For example, the WTRU may use one resource pool (e.g., a dedicated resource pool) if a SL-RSRP of the data communication between two WTRUs is smaller than a threshold. Otherwise, the WTRU may use another resource pool (e.g., a shared resource pool). The SL-RSRP threshold may be (pre-)configured in the resource pool and/or indicated to the WTRU from another node (e.g., gNB or another WTRU). The SL-RSRP threshold may be (pre-)configured as a function of the QoS of the positioning service (e.g., the accuracy/priority requirement of the positioning service).

The WTRU may determine which resource pool to use for SL-PRS transmission based on one or more parameters (pre-)configured in the resource pool. The parameters (pre-)configured in the resource pool may be one or more of a maximum and/or minimum bandwidth for SL-PRS, the parameters for open loop power control (OLPC), closed loop power control (CLPC) transmission power (e.g., maximum power, whether SL or DL pathloss compensation is (pre-)configured and the associated values of alpha and P0), the set of allowable SL-PRS patterns, channel occupancy for SL-PRS transmission, sidelink positioning, and/or sidelink data communication, the priority of SL-PRS in a shared resource pool, the maximum number of WTRUs in a group for sidelink positioning (e.g., which may be explicitly (pre-)configured or may be implicitly determined based on the amount of resources or feedback resources (pre-)configured in the resource pool), and/or CBR thresholds in the resource pool. In an example, the WTRU may prioritize the resource pool with a higher bandwidth for SL-PRS transmission. In an example, the WTRU may prioritize the resource pool allowing higher channel occupancy for SL-PRS transmission or sidelink positioning. In an example, the WTRU may prioritize the resource pool without OLPC. In an example, the WTRU may prioritize the resource pool allowing a denser comb pattern for SL-PRS. In an example, the WTRU may prioritize the resource pool supporting a higher number of WTRUs in a group. In an example, the WTRU may prioritize the resource pool allowing a denser SL-PRS pattern. In an example, the WTRU may prioritize the resource pool allowing comb-1 SL-PRS, in which the SL-PRS is in all resource elements (REs) of a symbol.

The WTRU may determine which resource pool to use for SL-PRS transmission based on sidelink positioning methods. For example, the WTRU may determine to select a shared resource pool for one set of positioning methods (e.g., the positioning methods not requiring transmission coordination among multiple WTRUs such as RTT, AoA, AoD). The WTRU may select a dedicated resource pool for another set of positioning methods (e.g., the positioning methods requiring coordination among multiple Tx WTRUs such as TDOA, sidelink carrier phase positioning).

The WTRU may determine which resource pool to use for SL-PRS transmission based on a number of required sidelink resources in a period. For example, the WTRU may select a first type of resource pool if the amount of required resources is smaller than a (pre-) configured threshold and the WTRU may select a second type of resource pool if the amount of required resources is larger than the threshold. The threshold of the number of resources may be (pre-)configured per resource pool.

The WTRU may determine which resource pool to use for SL-PRS transmission based on a number of WTRUs in a positioning group. For example, the WTRU may select one resource pool or one type of resource pool (e.g., dedicated resource pool) if the number of WTRUs in the sidelink positioning group is greater than a threshold. Otherwise, the WTRU may select another resource pool or another type of resource poos (e.g., shared resource pool). The threshold of the number of WTRUs in the group may be (pre-)configured per resource pool.

The WTRU may determine which resource pool to use for SL-PRS transmission based on a CBR of the resource pool. For example, the WTRU may prioritize the resource pool having a lower CBR.

The WTRU may determine which resource pool to use for SL-PRS transmission based on an indication from another node. For example, the WTRU may receive an indication from another node (e.g., an anchor WTRU or gNB) for which resource pool to perform SL-PRS transmission. The WRTU may select the indicated resource pool from the other node.

A WTRU may switch the transmission resource pool for SL-PRS. In an embodiment, the WTRU may use one resource pool for SL-PRS transmission. For one resource selection for SL-PRS, the WTRU may determine whether to keep the same resource pool or select another resource pool. The decision may be based on one or any combination of the following: CBR of the resource pool, channel occupancy ratio (CR) of SL-PRS transmission of the WTRU in the resource pool, implicit/explicit indication from another WTRU, and the sidelink positioning measurement reporting status from another WTRU.

The decision whether to keep the same resource pool or select another resource pool may be based on a CBR of the resource pool. For example, the WTRU may switch to another resource pool if the CBR of the resource pool is greater than a threshold. If the CBR of the resource pool is smaller than the threshold, the WTRU may use the same resource pool for SL-PRS transmission.

The decision whether to keep the same resource pool or select another resource pool may be based on channel occupancy ratio (CR) of SL-PRS transmission of the WTRU in the resource pool. For example, the WTRU may switch to another resource pool if the CR of SL-PRS of the WTRU in the resource pool is greater than a threshold. For example, the WTRU may be (pre-)configured with a maximum CR for SL-PRS. The WTRU may switch to another resource pool if it reaches the maximum allowed CR for SL-PRS.

The decision whether to keep the same resource pool or select another resource pool may be based on an implicit/explicit indication from another WTRU. For example, the WTRU may receive an indication from another WTRU (e.g., anchor WTRU or target WTRU) to switch to a different resource pool. The WTRU may switch to another resource upon the reception of the indication.

The decision whether to keep the same resource pool or select another resource pool may be based on a sidelink positioning measurement reporting status from another WTRU. For example, the WTRU may determine to switch to another resource pool based on the sidelink positioning measurement reporting status from another WTRU.

For example, the WTRU may switch to another resource pool if a measured reporting does not satisfy a condition (e.g., SL-RSRP is smaller than a threshold or the error in timing measurement is greater than a threshold). The SL-RSRP threshold and/or timing measurement threshold may be based on the QoS of the positioning service. The WTRU may switch to another resource pool if it does not receive measurement reporting from another WTRU (e.g., anchor WTRU or target WTRU) for a period.

A WTRU may determine the granularity of a selected resource for SL-PRS transmission. In an example, the WTRU may perform resource allocation for one or more SL-PRS transmissions. The WTRU may determine the availability of each resource in the resource selection window. The WTRU may determine the granularity of each resource to determine its availability. The granularity of each resource in a time domain may be one or any combination of a RE level, a SL-PRS duration level, or a slot level.

The granularity of each resource in a time domain may be a RE level. For example, the WTRU may select one SL-PRS pattern to transmit and may determine the availability of each RE in the SL-PRS pattern. For example, the WTRU may determine whether there is any WTRU reserving resource (e.g. SL-PRS resource) colliding with one or more REs of its selected SL-PRS pattern.

The granularity of each resource in a time domain may be a SL-PRS duration level. For example, the WTRU may be (pre-)configured with multiple time-domain SL-PRS resources in a slot. The WTRU may determine the availability of each SL-PRS resource in the time domain.

The granularity of each resource in a time domain may be on a slot level. For example, in the time domain, the WTRU may determine the availability of each slot. The WTRU may determine whether there is any WTRU reserving resources (e.g. for SL-PRS transmission) in the slot. The WTRU may determine the slot as available if there is no WTRU reserving a colliding resource in the slot (e.g. there is no WTRU reserving s resource in the slot and the measured SL-RSRP is greater than a threshold).

The WTRU may determine the availability of a resource in the frequency domain. The WTRU may determine the granularity of each resource to determine its availability in the frequency domain. The granularity of each resource in frequency domain may be one or any combination of the following: RE level, subchannel level, and resource pool bandwidth level.

The WTRU may determine the granularity of a selected resource for SL-PRS transmission based on one or any combination of the following.

The WTRU may determine the granularity of a selected resource for SL-PRS transmission based on a (pre-)configuration in the resource pool.

The WTRU may determine the granularity of a selected resource for SL-PRS transmission based on an implicit/explicit indication from another node (e.g. another WTRU, gNB, or LMF).

The WTRU may determine the granularity of a selected resource for SL-PRS transmission based on a QoS requirement of the positioning service. For example, the WTRU may determine the slot level resource availability granularity if the QoS (e.g. accuracy requirement) of the positioning service is greater than a threshold, otherwise, the WTRU may determine the RE level granularity if the QOS of the positioning service (e.g. accuracy requirement) is smaller than a threshold.

The WTRU may determine the granularity of a selected resource for SL-PRS transmission based on a CBR of the resource pool. For example, the WTRU may determine the slot level resource availability granularity if a CBR of the resource pool is smaller than a threshold, otherwise, if the CBR of the resource pool is larger than a threshold, the WTRU may use the SL-PRS duration level granularity. Alternatively, if the CBR of the resource pool is larger than another threshold, the WTRU may use the RE level resource granularity.

The WTRU may determine the granularity of a selected resource for SL-PRS transmission based on a CR sidelink transmission and/or SL-PRS transmission of the WTRU.

The WTRU may determine the granularity of a selected resource for SL-PRS transmission based on the bandwidth determined to be used for SL-PRS transmission. For example, the WTRU may use RE level resource granularity if the determined bandwidth of SL-PRS is greater than a threshold, otherwise, if the determined bandwidth is smaller than a threshold, the WTRU may use slot level resource granularity.

The WTRU may determine the granularity of a selected resource for SL-PRS transmission based on the number of symbols for associated control signaling, AGC and/or TX/RX switch symbols. For example, if the number of symbols for associated control signaling, AGC (Automatic Gain Control), SL-PRS and/or Tx/Rx switching is larger than a threshold, the WTRU may use slot level resource granularity. Otherwise, if the number of associated control signaling, ACG, SL-PRS, and/or Tx/Rx switching is smaller than the threshold, the WTRU may use mini-slot level (e.g., SL-PRS resource level) resource granularity.

The WTRU may determine the granularity of a selected resource for SL-PRS transmission based on the ratio of available candidate resources within the RSW. For example, a WTRU may perform a resource selection using a different type of resource when the ratio is below a (pre)configured threshold. For example, a WTRU may switch from using a Type 1 resource to a Type 2 resource in the resource selection.

A WTRU may determine SL-PRS transmission parameters. In an example, a WTRU may perform SL-PRS transmission(s). The WTRU may determine one or more of SL-PRS transmission(s) parameters, which may include one or any combination of the following.

The one or more SL-PRS transmission parameters may include the parameters of a SL-PRS resource, which may include one or any combination of the following parameters: the QoS associated with the SL-PRS resource, the transmission power, the number of subchannels used for each SL-PRS resource, the number of symbols/slots used for each SL-PRS transmission resource, the reference resource pattern (e.g. comb size, RE Offset, and/or comb pattern), a sequence ID, a cyclic shift, and time/frequency resource(s) of SL-PRS transmission(s).

The one or more SL-PRS transmission parameters may include the number of SL-PRS resource repetitions/retransmissions in a period.

The one or more SL-PRS transmission parameters may include the type of SL-PRS transmission. For example, the WTRU may determine whether the SL-PRS transmission is periodic, aperiodic, or semi-persistent.

The one or more SL-PRS transmission parameters may include the periodicity of a SL-PRS process. For example, the WTRU may determine to perform periodic or semi-persistent SL-PRS transmission. The WTRU may then determine the periodicity of the SL-PRS transmission.

The one or more SL-PRS transmission parameters may include the number of periods for one SL-PRS process, sidelink positioning session, and/or the window. For example, the WTRU may determine the number of periods to transmit SL-PRS. The number of periods and/or the number of remaining periods for SL-PRS transmission may be indicated in the associated transmission of the SL-PRS (e.g. in the SCI associated with the SL-PRS).

A WTRU may determine the selectability of a resource. In an embodiment, a WTRU may perform resource selection in a resource pool allowing resource sharing among multiple types of transmissions (e.g., sharing between SL-PRS and sidelink data). The WTRU may perform sensing in a sensing window to detect the resource reservation of resources in the resource selection window. The WTRU may determine whether a reserved resource in the resource selection window is selectable or not. If the WTRU determines the reserved resource as selectable, the WTRU may include the reserved resource from the set of selectable resources, and it may select the resource for its transmission. Otherwise, if the WTRU determines the reserved resource as unselectable, the WTRU may exclude the reserved resource from the set of selectable resources, and the WTRU may not select the reserved resource for its transmission. The selectability of a reserved resource may be determined based on whether the reserved resource is used for a first type of transmission (e.g., SL-PRS) or a second type of transmission (e.g., normal sidelink data) and/or the SL-RSRP measured in the reserving transmission. The type of transmission in the reserved resource may be indicated in the SCI of the reserving transmission.

In an embodiment, a WTRU may be (pre-)configured with two SL-RSRP thresholds to determine the selectability/availability of a reserved resource, in which a first SL-RSRP threshold may be used for a first type of reserved resource (e.g., for SL-PRS transmission) and a second SL-RSRP threshold may be used for a second type of reserved resource (e.g., for sidelink data transmission). If the resource is reserved for the first type of transmission, the WTRU may determine the reserved resource as selectable if the SL-RSRP is smaller than the first SL-RSRP threshold. If the resource is reserved for the second type of transmission, the WTRU may determine the resource as selectable if the SL-RSRP is smaller the second SL-RSRP threshold. In another example, the WTRU may consider the resource reserved by one type of resource (e.g., the resource reserved for SL-PRS) as unselectable without considering SL-RSRP of the transmission reserving the resource.

A WTRU may reserve a resource for a type of sidelink transmission. In an embodiment, a WTRU may perform sidelink transmission. The WTRU may reserve a resource for a potential transmission. The WTRU may indicate (e.g., in the SCI of the transmission) whether the reserved resource is used for a first type of transmission (e.g., SL-PRS) or a second type of transmission (e.g., normal sidelink data).

A WTRU may indicate a priority of the reserved resource for SL-PRS. In an embodiment, the WTRU may reserve a resource for SL-PRS transmission. The WTRU may indicate the QoS (e.g., priority) associated with the reserved resource for SL-PRS transmission (e.g., in the SCI of the reserving transmission). In a first example, the WTRU may be (pre-)configured with a priority for SL-PRS. The WTRU may indicate the (pre-)configured priority in the reserving transmission (e.g., in the SCI). In another example, the WTRU may indicate (e.g., one bit indicator in the SCI associated with the reserving transmission) that the reserved resource may be used for one type of transmission (e.g., SL-PRS transmission).

A WTRU may indicate the information about a SL-PRS resource. The WTRU may indicate the information about the SL-PRS, which may be indicated in a SCI, MAC CE, PC5, and/or NAS (e.g., LPP, i.e., LTE Positioning Protocol) of an associated transmission. For example, the WTRU may indicate the time and frequency of the SL-PRS in a first SCI. The WTRU may indicate one or any combination of the following information in the first SCI, second SCI, MAC CE, and/or PC5 RRC of the associated transmission: the SL-PRS pattern, which may include the SL-PRS pattern index, time and frequency offset, comb-size, and/or the number of SL-PRS symbols for one SL-PRS resource, and the receiver(s) of the SL-PRS (e.g., the destination ID associated with the SL-PRS).

A WTRU may take action when the number of available resources for SL-PRS transmission is small. In an embodiment, if the number of available resources for SL-PRS transmission in a resource pool (e.g., a shared or a dedicated resource pool) is smaller than a threshold, which may be (pre-)configured in the resource pool, the WTRU may perform one or any combination of the following.

The WTRU may perform selection and transmission from the current set of available resources. For example, if the number of available resources for SL-PRS is smaller than a threshold, the WTRU may select one or more resource for SL-PRS from the set of currently available resources. The WTRU may determine whether to perform such a procedure based on a QoS of the sidelink positioning service. For example, the WTRU may perform such a procedure if the QoS of the sidelink positioning service satisfies a condition (e.g., latency of the positioning service is smaller than a threshold), otherwise, the WTRU may perform another procedure such as indicating to another node, switching to another resource pool, and/or increasing SL-RSRP threshold.

The WTRU may increase a SL-RSRP threshold. For example, the WTRU may determine whether to increase the SL-RSRP threshold to have more available resources for SL-PRS transmission based on one or more of the QoS of the sidelink positioning service. For example, the WTRU may increase the SL-RSRP threshold if the latency of the positioning service is smaller than a threshold, otherwise, the WTRU may perform another procedure (e.g., sending an indication to another node). This approach may be motivated to help the WTRU find enough available resources for SL-PRS transmission in case of a low latency positioning service.

For example, the WTRU may increase a SL-RSRP threshold if the accuracy/priority of the positioning service is smaller than a threshold, otherwise, the WTRU may not increase the SL-RSRP threshold. The WTRU may perform another procedure such as switching the resource pool, indicating to another node, and/or changing the SL-PRS pattern.

The WTRU may send an indication to another node (e.g., gNB or another WTRU such as anchor or target WTRU). For example, the WTRU may send an indication to another node to implicitly/explicitly indicate that the number of resources for SL-PRS transmission is smaller than the threshold. The WTRU may send a request to change the SL-PRS pattern.

The WTRU may change the SL-PRS pattern. For example, the WTRU may change the SL-PRS pattern if the number of available resources for SL-PRS transmission is smaller than a threshold. For example, the WTRU may reduce the transmission bandwidth or increase the comb size (i.e., reduce the density of SL-PRS REs).

The WTRU may trigger resource pool (re-)selection. For example, the WTRU may reselect another resource pool (e.g., switch to a dedicated resource pool) if the number of available resources for SL-PRS transmission is smaller than a threshold.

A WTRU may determine whether to prioritize SL-PRS or data transmission in a sidelink resource.

In an example, a WTRU may have one sidelink resource for potential sidelink transmission. The WTRU may determine whether to prioritize SL-PRS, sidelink data transmission, or both based on one or any combination of the following. The WTRU may determine whether to prioritize SL-PRS, sidelink data transmission, or both based on the priority associated with SL-PRS and the priority associated with data transmission. For example, the WTRU may prioritize the transmission having higher priority. The WTRU may determine whether to prioritize SL-PRS, sidelink data transmission, or both based on the QOS requirement of SL-PRS and the bandwidth of the sidelink data. For example, the WTRU may be (pre-)configured with a minimum bandwidth for SL-PRS transmission and may determine not to transmit SL-PRS in the sidelink resource if the bandwidth of the sidelink resource is smaller than a (pre-)configured minimum bandwidth for SL-PRS, and otherwise, may consider transmitting SL-PRS in the sidelink resource.

A WTRU may determine whether to embed SL-PRS in a sidelink transmission.

In an example, in a sidelink resource, the WTRU may determine to prioritize sidelink data transmission. The WTRU may determine whether to embed SL-PRS in the sidelink resource based on one or any combination of the following. The WTRU may determine whether to embed SL-PRS in the sidelink resource based on the destination associated with the SL-PRS and the sidelink data. For example, the WTRU may embed SL-PRS with sidelink data if they are associated with the same destination (e.g. the same L2 destination ID). For example, the WTRU may embed SL-PRS with sidelink data if the WTRU receiving SL-PRS belongs to the set of receivers for sidelink data. The WTRU may determine whether to embed SL-PRS in the sidelink resource based on the cast type associated with SL-PRS and sidelink data. For example, the WTRU may embed SL-PRS with sidelink data if they are associated with broadcast service.

A WTRU may determine which SL-PRS to prioritize. In an example, in a sidelink resource, the WTRU may determine to transmit sidelink data transmission. The WTRU may determine to prioritize SL-PRS transmission associated with the same destination ID (e.g. L2 Destination ID) of the sidelink data. In another example, in a sidelink resource, the WTRU may determine to prioritize SL-PRS transmission. The WTRU may determine to build a TB for sidelink data having the same destination ID associated with the prioritized SL-PRS.

A WTRU may determine the priority of a SL-PRS transmission associated with sidelink data. In an embodiment, a WTRU may transmit SL-PRS with sidelink data. The WTRU may determine the priority of the transmission based on the priority of both the SL-PRS and sidelink data. For example, the priority of the transmission (e.g. the priority indicated in the SCI) may be the highest priority of the SL-PRS and sidelink data.

A WTRU may determine how to indicate in a SCI of a SL-PRS transmission. A WTRU may determine how to indicate the priority of SL-PRS transmission in a SCI (e.g. the first SCI). In an example, the WTRU may indicate a (pre-)configured priority for each SL-PRS transmission in a SCI (e.g. the highest priority). If the priority of the SL-PRS transmission is greater than the (pre-)configured priority to indicate in the SCI, the WTRU may indicate the real priority of the SL-PRS transmission. In an example, the WTRU may be (pre-)configured with an offset of priority to indicate in the SCI. The WTRU may then calculate or determine the priority to indicate in the SCI (e.g. the first SCI) based on the priority provided by a higher layer (e.g. MAC layer) and the (pre-)configured offset value. For example, the priority to indicate in the SCI may be the priority provided by a higher layer minus the (pre-)configured offset. The WTRU may indicate the priority indicated by the higher layer of SL-PRS in another field of the first SCI, in the second SCI and/or in MAC CE.

A WTRU may be (pre-)configured with a PSFCH occasion to transmit a second SL-PRS in a RTT method. In an embodiment, a WTRU may use a PSFCH as a second SL-PRS transmission for a RTT positioning method. For example, the WTRU may be (pre-)configured with a PSFCH resource (e.g. in the same slot as the PSFCH resource for sidelink data). The WTRU may be further (pre-)configured with a mapping between a PSCCH/PSSCH resource to transmit the first SL-PRS and associated PSFCH for a second SL-PRS. Upon detection of the SL-PRS transmission in the PSCCH/PSSCH resource, the WTRU may transmit the SL-PRS in the associated PSFCH.

A WTRU may indicate its first SL-PRS transmission and request a receiving WTRU to transmit the second SL-PRS in a PSFCH. A WTRU may indicate its first SL-PRS transmission in a PSCCH/PSSCH resource. It may implicitly and/or explicitly request a receiving WTRU to transmit the second SL-PRS in in the associated PSFCH resource for a RTT positioning method. Such request/indication may be conveyed in a SCI and/or MAC CE of the associated SL-PRS transmission. In the PSCCH/PSSCH resource, the WTRU may transmit a standalone SL-PRS or SL-PRS with sidelink data.

A WTRU may determine whether to transmit a PSSCH-DMRS for a standalone SL-PRS. In an embodiment, a WTRU may determine whether to transmit a standalone SL-PRS in a shared resource pool. The WTRU may transmit a PSSCH-DMRS in a slot having a SL-PRS. The WTRU may determine whether to transmit a PSSCH-DMRS in the transmission (e.g. to support backward compatibility in supporting R16/17 WTRUs in resource allocation) based on one or any combination of the following. The WTRU may determine whether to transmit a PSSCH-DMRS in the transmission based on a (pre-)configuration in the resource pool. For example, the WTRU may be (pre-)configured in the resource pool whether to transmit PSSCH-DMRS or not. The WTRU may determine whether to transmit a PSSCH-DMRS based on resource pool configuration. The WTRU may determine whether to transmit a PSSCH-DMRS in the transmission based on a resource allocation mode. For example, for Mode 1, the WTRU may not transmit a PSSCH-DMRS, and for Mode 2, the WTRU may transmit a PSSCH-DMRS. The WTRU may determine whether to transmit a PSSCH-DMRS in the transmission based on whether a PSSCH-DMRS or PSCCH-DMRS is (pre-)configured for resource allocation in the resource pool. For example, the WTRU may transmit a PSSCH-DMRS if PSSCH-DMRS is (pre-)configured for resource allocation. Alternatively, if PSCCH-DMRS is (pre-)configured for resource allocation, the WTRU may not transmit a PSSCH-DMRS in a standalone SL-PRS.

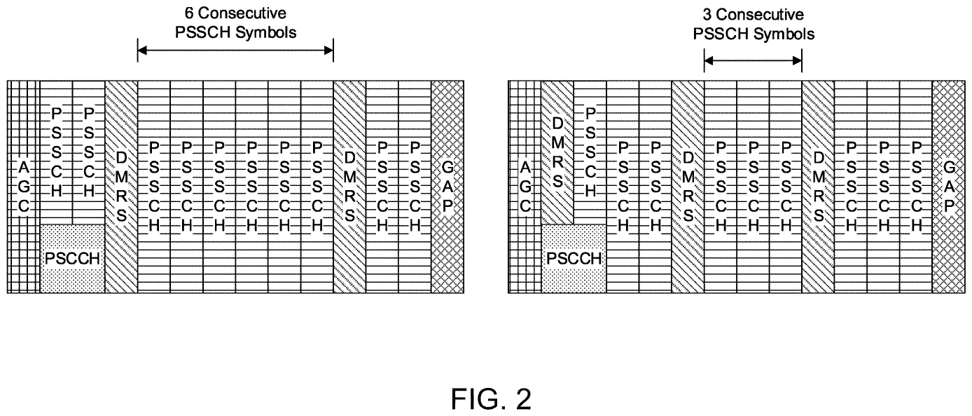

A WTRU may determine the maximum SL-PRS duration based on the (pre-)configured PSSCH-DMRS patterns in the resource pool. The WTRU may determine the maximum SL-PRS duration based on the set of (pre-)configured PSSCH-DMRS patterns in the resource pool. For example, for each (pre-)configured PSSCH-DMRS pattern, the WTRU may determine a maximum number of consecutive symbols for PSSCH. The maximum SL-PRS duration may be determined based on the maximum number of consecutive symbols for PSSCH. The WTRU may determine the maximum SL-PRS duration based on the PSSCH-DMRS pattern having the maximum number of consecutive symbols for PSSCH. For example as shown in FIG. 2, the WTRU may be (pre-)configured with two PSSCH-DMRS patterns, in which the first PSSCH-DMRS pattern has a maximum of six consecutive PSSCH symbols, which may allow the WTRU to transmit a SL-PRS with the maximum duration of six symbols. The second PSSCH-DMRS pattern has a maximum of three consecutive PSSCH symbols, which may allow the WTRU to transmit a SL-PRS with the maximum duration of three symbols.

A WTRU may determine which PSSCH-DMRS pattern to transmit based on the selected SL-PRS duration. In an embodiment, a WTRU may be (pre-)configured with multiple PSSCH-DMRS patterns, in which each PSSCH-DMRS pattern may have a maximum potential SL-PRS duration. The WTRU may determine which PSSCH-DMRS pattern to transmit based on the selected SL-PRS pattern (e.g. the intended SL-PRS duration).

A WTRU may indicate SL-PRS parameters for its associated SL-PRS pattern. In an embodiment, a WTRU may indicate one or any combination of the following parameters regarding the SL-PRS pattern(s) to be transmitted in a slot: a number of SL-PRS pattern in the slot (e.g. the WTRU may determine whether to transmit a SL-PRS pattern for each set of consecutive slots for PSSCH and may further indicate which set of consecutive slots the WTRU is transmitting SL-PRS); a comb-size; RE-offset; SL-PRS duration; a time-frequency resource for each SL-PRS pattern; SL-PRS resource ID; SL-PRS sequence ID, or other IDs used to generate SL-PRS sequence; SL-PRS resource element offset; SL-PRS resource slot offset; SL-PRS QCL information; SL-PRS resource set ID; SL-PRS resource power; periodicity of SL-PRS transmission; the number of periods for SL-PRS transmission; spatial direction information of SL-PRS transmission (e.g. beam information, angles of transmission); spatial direction information of SL-RS reception (e.g. beam ID used to receive SL-RS, angle of arrival); frequency layer ID; WTRU ID; and SL-PRS ID.

A WTRU may determine where to indicate SL-PRS information. A WTRU may determine where to indicate SL-PRS information (e.g. in a first SCI, second SCI, and/or MAC CE) based on whether it is transmitting standalone SL-PRS or SL-PRS with sidelink data. For example, if the WTRU transmits standalone SL-PRS, the WTRU may use the first SCI to indicate SL-PRS information. Alternatively, if the WTRU transmits SL-PRS with sidelink data, the WTRU may use the second SCI and/or MAC CE to indicate SL-PRS information. For example, for standalone SL-PRS, the WTRU may use one or a combination of more than one (pre-)configured fields in the SCI (e.g. 2nd stage SCI format, beta offset, MCS, MCS table, etc.) to transmit SL-PRS information. For SL-PRS transmission with data, the WTRU may use a second SCI to indicate SL-PRS information. For example, the WTRU may be (pre-)configured with a new second SCI format (e.g. SCI format 2-C). In an example, the WTRU may use one codepoint in the second stage SCI format to indicate the new second SCI. In another example, the WTRU may use one reserved bit, to indicate a new second SCI format.

A WTRU may indicate information for standalone SL-PRS. In an example, the WTRU may use an SCI to indicate the information of standalone SL-PRS. In another example, the WTRU may use a second SCI (e.g. a new SCI format) and/or MAC CE to indicate the information regarding standalone SL-PRS.

A WTRU may indicate information for transmission of SL-PRS with data. In an example, the WTRU may use a second SCI (e.g. a new SCI format) and/or MAC CE to indicate the information regarding standalone SL-PRS.

In an embodiment, a WTRU may determine to transmit a SL-PRS with sidelink data. In an example, the WTRU may transmit a SL-PRS and sidelink data using TDM (e.g. sidelink data and SL-PRS occupy two different sets of symbols). In an example, the WTRU may multiplex a SL-PRS and sidelink data at a resource element (RE) level. For example, a SL-PRS and sidelink data may be multiplexed in the same symbol but they may occupy a different set of REs. The WTRU may indicate the multiplexing scheme between SL-PRS and sidelink data in an associated SCI transmission. For example, the WTRU may indicate the multiplexing scheme between SL-PRS and sidelink data in a second SCI. The WTRU may determine which multiplexing scheme (e.g. TDM or RE level) between SL-PRS and sidelink data to use based on one or any combination of (re-)configuration, QoS of data, and/or QoS of SL-PRS, cast type associated with data and/or SL-PRS, destination associated with data and/or SL-PRS.

The WTRU may determine which multiplexing scheme (e.g. TDM or RE level) between a SL-PRS and sidelink data to use based on a (pre-)configuration in the resource pool. For example, in one resource pool the WTRU may be (pre-)configured to perform TDM multiplexing between SL-PRS and sidelink data. In another resource pool, the WTRU may be (pre-)configured to multiplex in a RE level between SL-PRS and sidelink data.

The WTRU may determine which multiplexing scheme (e.g. TDM or RE level) between a SL-PRS and sidelink data to use based on a QoS of data and/or a QoS of SL-PRS. For example, for low QoS SL-PRS, the WTRU may multiplex between a SL-PRS and sidelink data using RE level multiplexing. Alternatively, for high QoS requirement (e.g. high accuracy or high priority), the WTRU may multiplex a SL-PRS with sidelink data using TDM multiplexing.

The WTRU may determine which multiplexing scheme (e.g. TDM or RE level) between a SL-PRS and sidelink data to use based on a cast type associated with data and/or a SL-PRS. For example, the WTRU may allow multiplexing between a SL-PRS and data using RE level for unicast transmission of SL-PRS and sidelink data. However, for broadcast transmission of SL-PRS, the WTRU may multiplex a SL-PRS and sidelink data using TDM multiplexing.

The WTRU may determine which multiplexing scheme (e.g. TDM, or RE level) between a SL-PRS and sidelink data to use based on a destination associated with data and/or a SL-PRS. For example, if a SL-PRS and sidelink data target the same destination, the WTRU may use RE-level multiplexing between the SL-PRS and sidelink data. Otherwise, the WTRU may use TDM multiplexing between the SL-PRS and sidelink data.

A WTRU may determine the type of available resource for SL-PRS transmission. In an embodiment, the WTRU may determine the set of available resources for SL-PRS transmission in a resource selection window. The WTRU may determine the type of each available resource for SL-PRS transmission in the resource selection window based on a potential multiplexing scheme with other reserved resources in the resource selection window. The WTRU may determine whether one available resource for SL-PRS transmission belongs to one or any combination of the following types. In a first type of resource, the SL-PRS resource may not multiplex in frequency with other reserved resource, and it also may not time multiplex in the same slot with other reserved resource. For example, for this type of resource, there is no other WTRU reserving the resource in the whole slot. In a second type of resource, the SL-PRS resource may multiplex in frequency with other reserved resource. For example, for this type of resource, it may be possible that there is one or more reservations in the same slot but in a different subchannel. In a third type of resource, the SL-PRS resource may multiplex in both time and frequency with other reserved resources. For example, for this type of resource, there may be another WTRU reserving a different SL-PRS pattern overlapping in a time-frequency resource, which may be orthogonal with the SL-PRS pattern of the WTRU. In a fourth type of resource, the SL-PRS resource may be multiplexed in the same time slot but in a different set of symbols with another reserved SL-PRS resource.

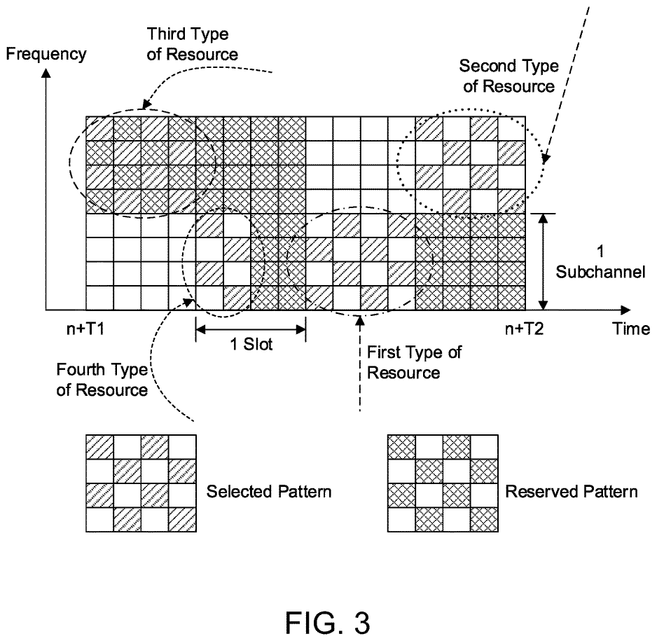

In an example shown in FIG. 3, a WTRU may select one or more SL-PRS patterns spanning over one slot in one subchannel. After the sensing window, the WTRU may be indicated or receive information regarding the set of reserved patterns/REs (shown in the reserved pattern). The WTRU may select one SL-PRS pattern, shown in the selected pattern, spanning over the bandwidth of one subchannel in one slot or half a slot. The WTRU may select the first type of resource, which is shown inside the First Type of Resource circle. In this type of resource, the SL-PRS pattern is not time or frequency multiplexed with any reserved resource. The WTRU may select the second type of resource, which is shown inside the Second Type of Resource circle. In this type of resource, the SL-PRS pattern may be frequency multiplexed within another reserved pattern in another subchannel. The WTRU may select the third type of resource, which is shown inside the Third Type of Resource circle. In this type of resource, the SL-PRS pattern may be both time and frequency multiplexed with another reserved pattern. The WTRU may select the fourth type of resource, which is shown inside the Fourth Type of Resource circle. In this type of resource, the SL-PRS pattern may be in the same slot with a reserved SL-PRSR pattern but in a different set of symbols.

A WTRU may determine which type of resource to select for SL-PRS transmission. In an embodiment, the WTRU may select one or more SL-PRS patterns in a resource selection window for SL-PRS transmission. The WTRU may prioritize one type of resource (e.g., a first type) over other type of resources (e.g., a second type) based on a potential multiplexing scheme with other reserved resource. In one example, the WTRU may select one or more SL-PRS resources with a higher probability of selecting one type of resource over another type of resources. In another example, the WTRU may first select (e.g., randomly select) one or more resources for SL-PRS from one type of resource (e.g., the first type of resource) if the number/percentage of that type of resources is greater than a threshold. Otherwise, if the number/percentage of that type of resource is smaller than a threshold, the WTRU may select (e.g., randomly select) one or more resources for SL-PRS from both types of resources (e.g., the first type and second type). The WTRU may continue to perform the procedure until it may select enough resources for SL-PRS transmission, or all type of resources are considered. The threshold of the number/percentage of selectable resources may be (pre-)configured in the resource pool, which may be fixed or configurable as a function of the QoS of the sidelink positioning service.

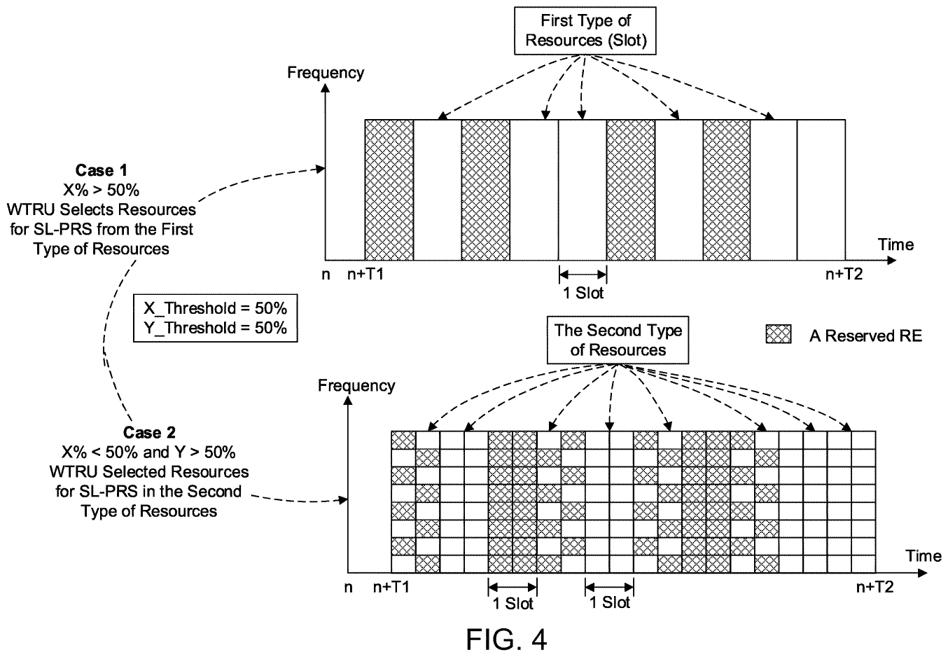

In an example shown in FIG. 4, a WTRU may select a resource for transmission of one SL-PRS pattern. For one available resource (e.g., an available SL-PRS pattern), the WTRU may determine whether the available resource belongs to a first type of resource or a second type of resource, in which the first type of resource includes the resource without any reservation (e.g., when the WTRU transmits SL-PRS in the resource, such SL-PRS may not overlap in time or frequency with any other transmission) in the slot and the second type of resource, which may have one SL-PRS pattern reserved in the slot (e.g., when the WTRU transmits SL-PRS in the resource, such SL-PRS may overlap in time and frequency with another transmission). The WTRU may first determine the set of resources that belong to the first type of resources. If the number/percentage of the first type of available resource is greater than a (pre-)configured threshold (e.g., X %), the WTRU may select (e.g., randomly select) one or more SL-PRS resources in the first type of resource. Otherwise, if the number/percentage of the first type of available resource is smaller than the threshold (e.g., smaller than X %) and the number/percentage of the first and second type of resources is larger than the second threshold (e.g., Y %), the WTRU may select one or more resources in the first type and second type of resources. If the number of available resources in both the first type and second type of resources is smaller than Y %, the WTRU may perform one or any combination of switching the resource pool, indicating to another node, increasing the SL-RSRP threshold, changing the SL-PRS pattern. The value of X and Y may be (pre-)configured, which may be a function of the QoS of the sidelink positioning service.

A WTRU may determine the selectability/availability of a SL-PRS pattern. In an embodiment, the WTRU may determine the selectability of a SL-PRS pattern based on a gap between the SL-PRS pattern and a reserved SL-PRS pattern. For example, the WTRU may consider the SL-PRS pattern as available if the gap (e.g., frequency gap) between the SL-PRS pattern and another reserved SL-PRS pattern is greater than a threshold. The threshold may be based on a QoS of the sidelink positioning service of the WTRU and/or the QoS of the service (e.g., sidelink positioning service) of the reserved resource.

A WTRU may determine the selectability/availability of a SL-PRS pattern based on a potential multiplexing between the SL-PRS pattern and a reserved SL-PRS pattern. For example, the WTRU may prioritize one type of SL-PRS (e.g., the first type of SL-PRS, in which the SL-PRS resource may not multiplex with other resources in the same slot) over another type of SL-PRS (e.g., the third type of SL-PRS, in which the SL-PRS resource may multiplex in both time and frequency with other reserved SL-PRS patterns) based on using two different SL-RSRP thresholds for each type of SL-PRS resources. For example, the WTRU may detect one WTRU reserving one SL-PRS pattern. The WTRU may determine the availability of the reserved pattern (e.g., whether the reserved SL-PRS pattern is selectable or not) based on the type of the reserved pattern (e.g., whether it is type one or other type of reserved patterns) and the associated SL-RSRP. For example, to determine the availability of the reserved SL-PRS, the WTRU may apply the first SL-RSRP threshold for the first type of SL-PRS and it may apply the second SL-RSRP threshold for the second type of SL-PRS.

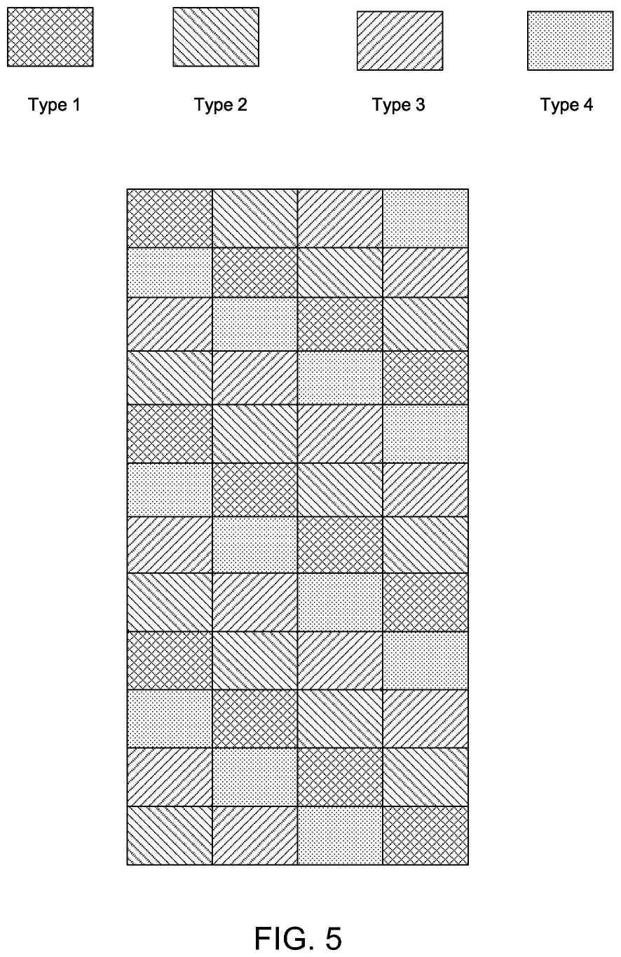

In an example shown in FIG. 5, the WTRU may consider one SL-PRS pattern as available if a frequency gap between the SL-PRS pattern and a reserved SL-PRS pattern is greater than one RE. The WTRU may detect a reserved first pattern, as indicated in the type 1 boxes. The WTRU may determine that a second pattern, as indicated with the type 2 boxes, is unavailable and may determine that a third pattern, as indicated by the type 3 boxes, is unavailable since the gap between the second/third pattern and the first pattern is one RE. However, the WTRU may consider the fourth pattern, as indicated in the type 4 boxes, as available since the gap between the fourth and the first pattern is two REs.

A WTRU may determine which type of resource to select for a SL-PRS transmission. The WTRU may determine which type of resource to select for a SL-PRS transmission based on one or any combination of the following.

The WTRU may determine which type of resource to select for a SL-PRS transmission based on the (pre-)configured type of resources in the resource pool. For example, the WTRU may be (pre-)configured with a certain type of SL-PRS resources in the resource pool. The WTRU may select one of the (pre-)configured types for a SL-PRS transmission. For example, the WTRU may be (pre-)configured with only a first type of resource (i.e. a resource without multiplexing in frequency and in the same slot with other SL-PRS resource). The WTRU may select the first type of resource for a SL-PRS transmission.

The WTRU may determine which type of resource to select for a SL-PRS transmission based on the QoS of the positioning service. For example, the WTRU may select the first type of resource for a high accuracy requirement. Alternatively, for a low accuracy requirement, the WTRU may select a second type of resource. For a low latency requirement, the WTRU may select a third type of resource. Otherwise, for a relaxed latency requirement, the WTRU may select the first or the second type of resources.

The WTRU may determine which type of resource to select for a SL-PRS transmission based on the CBR of the resource pool. For example, the WTRU may select the first type of resource if CBR of the resource pool is smaller than a threshold. Otherwise, if CBR of the resource pool is larger than a threshold, the WTRU may select the third type of resource.

The WTRU may determine which type of resource to select for a SL-PRS transmission based on: an indication from another node (e.g. another WTRU), a positioning method, a cast type of the SL-PRS transmission, a distance to the receiving WTRU and/or requesting WTRU, a sidelink channel to the receiving WTRU and/or requesting WTRU, a positioning accuracy of the WTRU or a positioning accuracy of an associated WTRU, the measurement parameters to be measured, an output of the positioning procedure, which may be absolute positioning or relative positioning, and an amount of SL-PRS transmission within a period.

A WTRU may determine the maximum time gap among transmissions of a SL-PRS. A WTRU (e.g. target WTRU) may select multiple SL-PRS resources to perform transmission and repetition of SL-PRS. The WTRU may determine the maximum time gap among transmissions of a SL-PRS (e.g. the maximum time gap between the initial transmission and the last repetition of SL-PRS in one SL-PRS period) based on one or any combination of the following. The WTRU may determine the maximum time gap based on a (pre-)configuration. For example, the WTRU may be (pre-)configured with a maximum time gap among transmissions of SL-PRSs in a period. The WTRU may select the SL-PRS resource to satisfy the (pre-)configured value. The WTRU may determine the maximum time gap based on an indication from a peer WTRU. For example, one WTRU (e.g. anchor WTRU) may indicate its maximum time gap among initial transmission and repetitions of a SL-PRS in a period to the WTRU (e.g. target WTRU). The receiver WTRU may determine the maximum time gap among initial transmission and repetitions of a SL-PRS based on its processing capability. In an example, the WTRU may indicate the maximum time gap to the network (e.g. gNB) to support the network in SL-PRS scheduling. In an example, the WTRU may consider the indicated maximum time gap in the resource allocation procedure. For example, the WTRU may select SL-PRS resources such that the maximum gap among SL-PRS resources is guaranteed. The WTRU may determine the maximum time gap based on a measurement gap/positioning processing window (MG/PPW) duration (pre-)configured for the receiver WTRU. For example, the WTRU may receive the MG/PPW configuration for the receiver WTRU, which may include the MG/PPW length. The transmitter WTRU (e.g. target WTRU) may determine that the maximum time gap among initial transmission and retransmission of a SL-PRS in a period to be smaller than the indicated MG/PPW length. This approach may be motivated to help the transmitter WTRU select the resource within the MG/PPW of the receiver WTRU. The WTRU may determine the maximum time gap based on a QoS (e.g. latency) of the positioning service. For example, the WTRU may be (pre-)configured with multiple maximum time gaps among transmissions of a SL-PRS in a period, in which each maximum time gap may be associated with one QoS requirement of the positioning service. The WTRU may determine which time gap to use for resource selection based on the required QoS of the positioning service. For example, for low latency requirement, the WTRU may use a small gap among transmissions of a SL-PRS in a period. Alternatively, for a less stringent latency requirement, the WTRU may select a larger maximum time gap among transmissions of a SL-PRS in a period. The WTRU may determine the maximum time gap based on a SL-PRS reception capability of the receiver WTRU. The WTRU may determine the maximum time gap based on a positioning method. For example, the WTRU may use the first maximum time gap for the first positioning method (e.g. SL-TDOA). Alternatively, the WTRU may use the second maximum time gap for the second positioning method (e.g., RTT). The WTRU may determine the maximum time gap based on the channel condition between the transmitter and receiver (e.g. the coherence time of the channel, the synchronization drift rate, the phase drift rate, etc.). For example, the WTRU may use a first maximum time gap among transmissions of SL-PRS in a period if the channel between the transmitter and receiver satisfies a first condition (e.g. coherence time is smaller than a (pre-)configured threshold). The WTRU may use a second maximum time gap among transmissions of SL-PRs in a period if the channel between two WTRUs satisfies a second condition (e.g. coherence time is larger than the threshold).

A WTRU may trigger SL-PRS resource (re)selection for a periodic SL-PRS process. In an embodiment, a WTRU may select a periodic SL-PRS process (e.g. each SL-PRS process may be associated with one HARQ process which may be similar to a periodic SL process) to transmit SL-PRS periodically. Before transmission in each SL-PRS period, the WTRU may determine whether to keep using the current SL-PRS process or reselect another SL-PRS process. Such decision may be determined based on one or any combination of the following. The decision may be based on a SL-PRS measurement reporting status from a peer WTRU. For example, the WTRU may trigger resource reselection for SL-PRS if the WTRU does not receive one or more expected SL-PRS measurement reporting from the peer WTRU. For example, the WTRU may trigger resource reselection for SL-PRS if the received SL-PRS measurement reporting from the peer WTRU indicates a poor result (e.g. SL-RSRP is smaller than a (pre-)configured threshold, or the peer WTRU implicitly indicates that it may not receive SL-PRS properly in one or more SL-PRS occasions). The decision may be based on one or more WTRUs being added/removed from the group. The decision may be based on whether a CBR of the resource pool is greater than a threshold and/or CR of the WTRU is greater than a threshold. The decision may be based on whether the peer WTRU indicates its MG/PPW configuration. In an example, upon the peer WTRU indicating its MG/PPW configuration, the WTRU may trigger resource selection if the WTRU does not have any periodic SL-PRS process selected for the peer WTRU. In an example, upon receiving the indication of MG/PPW configuration from the peer WTRU, the WTRU may trigger resource reselection if the existing periodic SL-PRS process does not align with the configured MG/PPW of the peer WTRU.

A WTRU may be (pre-)configured with multiple types of dedicated resource pools for SL-PRS. In an embodiment, a WTRU may be (pre-)configured with one or more resource pools for SL-PRS, in which one resource pool may have one or any combination of the following parameters. A parameter may be the number of TDM mini-slots for SL-PRS (e.g. X mini-slots for SL-PRS) in one slot. One resource pool may have one mini-slot for SL-PRS, which may span over the whole slot. Another resource pool may have two TDM mini-slots for SL-PRS. Another resource pool may have three TDM mini-slots for SL-PRS. A parameter may be whether the resource pool allows Tx-Rx switching between mini-slot SL-PRSs. For example, one resource pool may allow Tx-Rx switching between mini-slot SL-PRS by having a GAP symbol between mini-slot SL-PRSs. Another resource pool may not allow Tx-Rx switching between mini-slot SL-PRS, in which the WTRU may not have GAP symbol between two mini-slot for SL-PRS. A parameter may be whether RE level multiplexing between two SL-PRS patterns is enabled/disabled. A parameter may be a location of PSCCH/PSSCH and/or SCI to indicate its associated SL-PRS (e.g. whether PSCCH/PSSCH and/or SCI to indicate its associated SL-PRS is at the beginning of a slot or at the beginning of each mini-slot for each SL-PRS).

A WTRU may determine the structure of each mini-slot for SL-PRS having an associated PSCCH. A WTRU may determine the structure of each mini-slot for SL-PRS. In an embodiment, a mini-slot may include PSCCH resources to indicate SL-PRS at the beginning of the mini-slot. For example, the mini-slot for SL-PRS may sequentially include one symbol for AGC (e.g. to converge AGC for PSCCH reception), one or more symbols for PSCCH after the AGC symbol, another symbol for AGC (e.g. to converge AGC for SL-PRS reception) after PSCCH symbols, one or more symbols for SL-PRS after the second AGC symbol, and a GAP symbol at the end of the mini-slot for SL-PRS may be optionally (pre-)configured. The WTRU may be (pre-)configured with one GAP symbol at the end of every mini-slot for SL-PRS. Alternatively, the WTRU may be (pre-)configured with one GAP symbol at the end of a slot only.

A WTRU may determine the structure of the whole slot having a PSCCH at the beginning of the slot. In an embodiment, a WTRU may be (pre-)configured with PSCCH symbols at the beginning of a slot which may be used to indicate an associated SL-PRS in a different mini-slot. For example, the WTRU may be (pre-)configured with multiple PSCCH resources, in which each PSCCH resource may be used to indicate one SL-PRS pattern in one mini-slot for SL-PRS. The WTRU may determine which PSCCH resource to indicate its SL-PRS pattern based on its selected SL-PRS pattern (e.g. which mini-slot the SL-PRS pattern is located and the comb size and a RE offset of the selected SL-PRS pattern). After one or more symbols for PSCCH, the WTRU may be (pre-)configured with one or more mini-slots for SL-PRS. In each mini-slot for SL-PRS, the WTRU may be (pre-)configured with an AGC symbol followed by one or more symbols for SL-PRS. In an example, the WTRU may be (pre-)configured with a GAP symbol after each mini-slot for SL-PRS. In an example, the WTRU may be (pre-)configured with a GAP symbol at the end of a slot only.

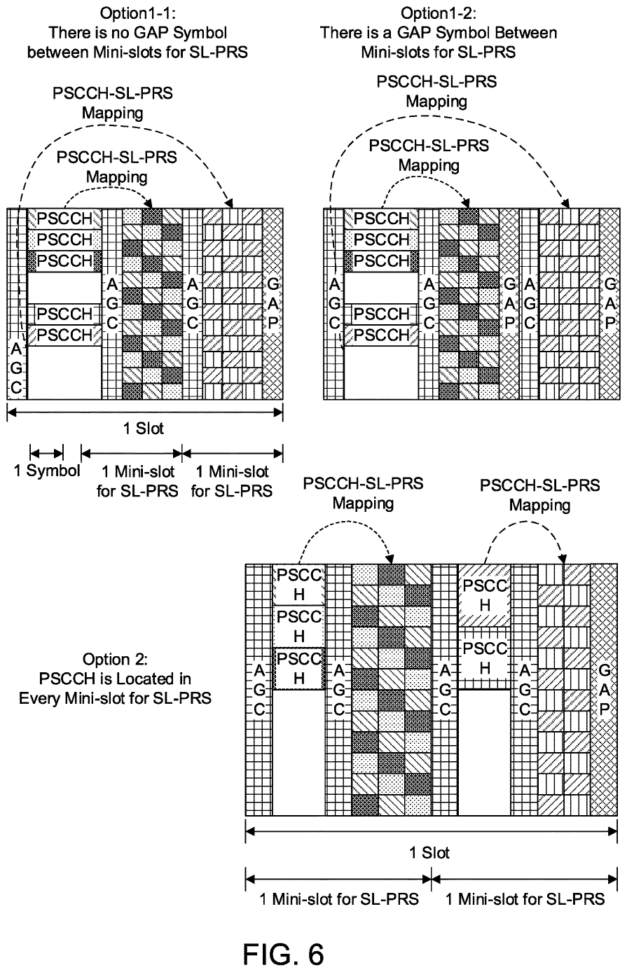

In an example as shown in FIG. 6, a WTRU may be (pre-)configured with one or more resource pools as in Option 1 (Option 1-1 and 1-2 ) and/or Option 2. In both Option 1 and Option 2, there are two mini-slots for SL-PRS in one slot. For Option 1, there is no GAP symbol between two mini-slots for SL-PRS in Option 1-1 while there is a GAP symbol between two mini-slots for SL-PRS in Option 1-2. In Option 1, a PSCCH region is located at the beginning of the slot. In Option 2, a PSCCH region is located at the beginning of every mini-slot for SL-PRS. The WTRU may be (pre-)configured with a mapping between PSCCH and SL-PRS, in which the WTRU may select which location of PSCCH to indicate the associated SL-PRS based on the selected SL-PRS pattern and time/frequency location of the SL-PRS.

A WTRU may determine which resource pool to request/select for SL-PRS transmission. In an embodiment, a WTRU may request from another node (e.g. another WTRU, gNB, LMF) a dedicated resource pool for SL-PRS transmission. In an embodiment, the WTRU may be (pre-)configured with multiple resource pools for SL-PRS. The WTRU may select one of the resource pools for SL-PRS transmission. The WTRU may determine which resource pool to request/select based on one or any combination of the following. The WTRU may determine which resource pool to request/select based on a QoS (e.g. latency, accuracy, reliability, range) of the positioning service. For example, for a high range of positioning service, the WTRU may request/select a resource pool with a higher SL-PRS duration in a resource pool. For example, the WTRU may request a resource pool in which a SL-PRS resource spans over the whole slot. For example, for a low latency requirement, the WTRU may request/select a resource pool having multiple mini-slots for SL-PRS TDMed in a slot. This approach may help the WTRU have more resources for SL-PRS transmission within a short period. The WTRU may determine which resource pool to request/select based on the positioning method. For example, for a SL-TDOA positioning method, the WTRU may request a resource pool without a GAP between two mini-slots for SL-PRS. Alternatively, for a RTT positioning method, the WTRU may request a resource pool having a GAP between two consecutive mini-slots for SL-PRS. This approach may be motivated to support a WTRU to transmit and receive within a slot. The WTRU may determine which resource pool to request/select based on availability of resources in a pool. For example, the WTRU may determine which resource pool to request/select based on availability of resources in each pool. The WTRU may determine a resource pool with a maximum availability (e.g. 90% availability) among a preconfigured resource pool. The WTRU may determine which resource pool to request/select based on a priority associated with resource pools. For example, the WTRU may be configured by the network or peer WTRU with a priority level for each resource pool. The WTRU may determine to select a resource pool associated with the priority level higher than a preconfigured threshold. In an example, the WTRU may receive an indication by a peer WTRU or network to use a subset of preconfigured resource pools.

A WTRU may select a second SL-PRS in response to a first SL-PRS resource of a RTT method. In an embodiment, a WTRU (e.g. anchor WTRU) may be involved in a positioning procedure for a RTT method. A WT RU may receive information about a first SL-PRS resource. The WTRU may determine to select a second SL-PRS in response to the first SL-PRS resource. The WTRU may first determine which SL-PRS resource to prioritize based on one or any combination of the following including a resource pool configuration. For example, if a GAP symbol between two mini-slots for SL-PRS is (pre-)configured, the WTRU may prioritize selecting the second SL-PRS resource (e.g. the response SL-PRS resource) in the same slot with the first SL-PRS resource. Alternatively, if a GAP symbol between two mini-slots for SL-PRS is not (pre-)configured, the WTRU may deprioritize selecting the second SL-PRS resource in the same slot with the first SL-PRS resource. The WTRU may prioritize selecting a second SL-PRS resource in a different slot.

A WTRU may prioritize SL-PRS resources in the same slot with the SL-PRS resource of WTRUs in a group. In an embodiment, a WTRU may perform resource selection for a positioning method (e.g. SL-TDOA). One WTRU (e.g. one anchor WTRU) may select the SL-PRS resource first and indicate the resource to other WTRUs in the positioning group. The WTRU may select a SL-PRS resource based on the indicated/reserved SL-PRS resource from the other WTRU. For example, the WTRU may prioritize selecting the SL-PRS resource in the same slot or adjacent slot with the indicated/reserved SL-PRS resource from the other WTRU. This approach may be motivated to help the group of WTRUs select adjacent SL-PRS resources.

A WTRU may determine a maximum SL-PRS transmission duration in the resource pool. A WTRU may determine the maximum SL-PRS transmission duration in the resource pool based on a (pre-)configured maximum number of SL-PRS symbols of a mini-slot for SL-PRS. For example, the WTRI may be (pre-)configured with a resource pool, in which in each slot, the WTRU may be (pre-)configured with multiple TDMed mini-slot for SL-PRS transmission. The WTRU may select the SL-PRS pattern, in which the maximum duration is limited by the maximum (pre-)configured number of SL-PRS symbols in a mini-slot.

A WTRU may determine a comb size N and a SL-PRS duration M for SL-PRS transmission. In an example, the WTRU may select a SL-PRS duration of M symbols to be equal to the duration of SL-PRS (pre-)configured in a mini-slot. In an example, the WTRU may select M symbols to be smaller than the duration of SL-PRS (pre-)configured in a mini-slot. If M is smaller than the SL-PRS duration (pre-)configured in a mini-slot, the WTRU may perform one or any combination of the following. The WTRU may transmit M symbols only and keep the remaining symbols of the mini-slot empty. The WTRU may repeat the selected SL-PRS pattern in the remaining symbols of the mini-slot. If after a certain number of repetitions, if the WTRU still has remaining symbols to fill, the WTRU may sequentially repeat each symbol in the SL-PRS pattern (e.g. from the first symbol of the SL-PRS pattern or from the last symbol of the SL-PRS pattern) until all symbols of the mini-slot for SL-PRS are filled.

The WTRU may be (pre-)configured with one or more procedures/rules to fill the SL-PRS symbols in a mini-slot, including keeping the remaining symbols unused. The WTRU may implicitly/explicitly indicate the procedure/rules it uses to fill the SL-PRS. The WTRU may indicate the procedure/rules in an associated SCI. This approach may be motivated to help the receiver WTRU in decoding SL-PRS properly.

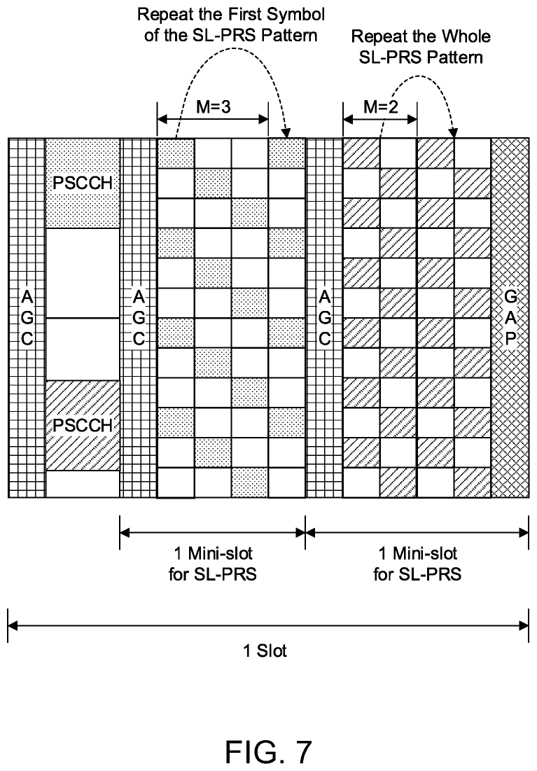

In an example shown in FIG. 7, the WTRU may determine to fill the remaining symbols of a mini-slot comprising four symbols for SL-PRS. In the first mini-slot for SL-PRS, the WTRU selects an SL-PRS pattern of M=3, the WTRU may repeat the first symbol of the selected SL-PRS pattern to fill the last symbol for SL-PRS of the mini-slot. In the second mini-slot, the WTRU selects a SL-PRS pattern of M=2.

In an embodiment, a WTRU may determine to transmit a SL-PRS pattern with a duration of M symbols greater than a number of SL-PRS symbols in a mini-slot. The WTRU may transmit a SL-PRS in multiple mini-slots in a slot, which may be consecutive. In an example, the WTRU may select one SL-PRS pattern in one mini-slot and the WTRU may repeat the selected SL-PRS pattern in a subsequent mini-slot(s). In an example, the WTRU may use one mini-slot to transmit a first part of the SL-PRS. The WTRU may use the subsequent mini-slot to transmit a remaining part of the SL-PRS pattern. In an example, the WTRU may transmit a SL-PRS across a mini-slot. The WTRU may transmit a SL-PRS in the symbols between two mini-slots (e.g. AGC symbols or GAP symbol). The WTRU may use an associated SCI to indicate such transmission behavior. For example, the WTRU may indicate the selected SL-PRS pattern, the number of mini-slots to transmit a SL-PRS pattern, whether cross mini-slot transmission is applied, and/or the whether the WTRU use SL-PRS repetition in multi mini-slots or the WTRU transmit different parts in different mini-slots.

A WTRU may determine to transmit SL-PRS in a duration shorter than the SL-PRS duration (pre-)configured in a mini-slot for SL-PRS. The WTRU may determine whether it may transmit SL-PRS in a duration shorter than the (pre-)configured SL-PRS duration in a mini-slot based on one or any combination of the following: bandwidth of the SL-PRS; comb size of the SL-PRS; and whether RE-level multiplexing between two SL-PRS patterns is allowed.

In an example, a WTRU may determine to transmit SL-PRS in a shorter duration than a (pre-)configured SL-PRS duration in a mini-slot if the SL-PRS spans the whole bandwidth of a resource pool and RE-level multiplexing between two SL-PRSs patterns is not allowed in the resource pool. In an example, the WTRU may determine to transmit SL-PRS in a shorter duration than the (pre-)configured SL-PRS duration in a mini-slot if the SL-PRS spans the whole bandwidth of the resource pool and FDM between two SL-PRS patterns may not be expected (e.g. the WTRU may use comb-1).

In an embodiment, a WTRU may determine to select a resource for itself and another peer WTRU. The WTRU may select one resource for itself and another resource for a peer WTRU's transmission. The WTRU may select the two resources such that a time gap between the two resources may need to satisfy one or more conditions. The minimum time gap between two resources may be determined based on the WTRU processing capability. The maximum time gap between the two resources may be determined based on the QOS of the positioning service. For example, for one accuracy requirement, the time gap between two SL-PRS resources may be smaller than a threshold. The threshold may be (pre-)configured as a function of the QoS of the positioning service (e.g. accuracy and/or latency requirement).

A WTRU may use an SCI to indicate/reserve resources for other WTRU's transmission. In an embodiment, the WTRU may use a SCI (e.g. the first SCI) to reserve resources for itself and other WTRU's transmission. In an example, the WTRU may use two bitfields (e.g. in the first SCI) to indicate/reserve resources for sidelink transmission (e.g. SL-PRS transmission) in which one bitfield may be used for reserving the resource for itself and another bitfield may be used for reserving the resource for the other WTRU's transmission. In an example, the WTRU may use one bitfield to reserve/indicate sidelink resources (e.g. for SL-PRS transmission). The WTRU may use one bit to indicate whether the reserved resources is used for itself or for other WTRUs. In an example, the WTRU may use one bitfield to indicate/reserve multiple sidelink resources (e.g. for SL-PRS transmission). The WTRU may reserve/indicate the first set of resources (e.g. the first resource in time) for its transmission. The WTRU may indicate the second set of resources (e.g. the second resource in time) for other WTRU's transmission.

In an embodiment, the WTRU may use one or more transmissions in one resource pool to indicate/reserve a transmission resource (e.g. SL-PRS) in another resource pool. The indicated/reserved transmission resource may be used by the WTRU to perform sidelink transmission. The indicated/reserved transmission resource may be used by another WTRU to perform a transmission. In an example, for inter-WTRU coordination the WTRU may use one or more transmissions in a sidelink data resource pool to indicate/reserve a SL-PRS resource for its peer WTRU in a dedicated resource pool for a SL-PRS transmission. In an example, for a RTT method, the WTRU may use one or more transmissions in one resource pool (e.g. a sidelink data resource pool) to indicate/reserve a SL-PRS resources in another resource pool (e.g. dedicated resource pool for SL-PRS) for itself and other WTRU's transmission. The WTRU may indicate (e.g. implicitly or explicitly) which resource is used for its SL-PRS transmission and which resource is used for other WTRU's transmission. In both examples, the WTRU may indicate the resource information for a SL-PRS transmission and reception to support the peer WTRU in performing a SL-PRS transmission and/or reception. Such information may comprise one or more of: resource pool ID, the SL-PRS time/frequency resource, the repetition, the SL-PRS pattern, and the periodicity of SL-PRS. The WTRU may use a SCI, MAC CE, RRC, and/or NAS (e.g. LPP for sidelink) to indicate/reserve a resource for SL-PRS in another resource pool (e.g. dedicated resource pool).

A WTRU may determine the availability of an indicated resource for SL-PRS transmission. In an embodiment, the WTRU may receive an indication (e.g. from a peer WTRU) of one or more resources for SL-PRS transmission. The WTRU may perform resource evaluation to determine whether the indicated resource is available. The WTRU may perform transmission (e.g. SL-PRS transmission) in the indicated resource if the resource is available. Otherwise, if the resource is not available, the WTRU may perform one or any combination of the following: send an indication to the peer WTRU and select another resource for SL-PRS transmission.

A WTRU may reselect one or more reserved/selected resources. In an embodiment, the WTRU may determine to reselect one periodic SL-PRS process. The WTRU may reselect the periodic SL-PRS process due to pre-emption (e.g. another WTRU reserving a colliding resource). The WTRU may determine the resource selection window for a new SL-PRS resource based on the timing of the associated periodic SL-PRS resource from the peer WTRI for a RTT-based sidelink positioning method. The WTRU may be expected to transmit SL-PRS before the peer WTRU performs SL-PRS transmission. The WTRU may select a resource selection window for a new SL-PRS, in which the latest slot in the resource selection window may be before the reserved SL-PRS resource of the peer WTRU in one period. The duration between the latest slot in the resource selection window and the reserved resource for SL-PRS transmission of the peer WTRU may be based on the processing capability of the WTRU. The WTRU may select the resource selection window.

A WTRU may trigger resource reselection due to pre-emption for itself and a peer WTRU. In an embodiment, the WTRU may perform pre-emption checking for the two resources in which one resource may be used for its transmission and another resource may be used for the peer WTRU's transmission. In an example, the WTRU may determine to reselect both SL-PRS resources if the time gap between the two resources is smaller than a threshold. This approach may be motivated to help the WTRU find suitable resources for both WTRUs to reduce the restriction in resource selection if the WTRU keeps one of the selected resource.

A WTRU may trigger resource selection for a periodic SL-PRS process. In an embodiment, the WTRU may reserve one periodic SL-PRS process associated with another periodic SL-PRS process of a peer WTRU. The WTRU may trigger resource reselection for the periodic SL-PRS process based on the detection of the change in the associated periodic SL-PRS process of the peer WTRU. If the WTRU detects a change in the periodic SL-PRS process of the peer WTRU (e.g. the peer WTRU performs resource reselection and changes to another periodic SL-PRS process), the WTRU may trigger resource selection and change to another periodic SL-PRS to accommodate the RTT sidelink positioning procedure.

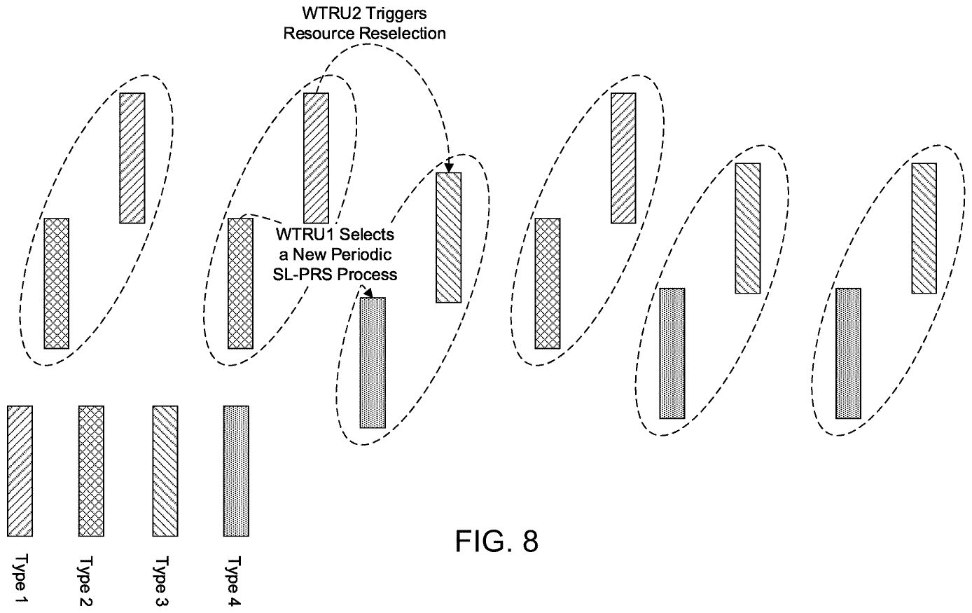

FIG. 8 shows an example of a WTRU triggering resource reselection upon detection of a change in an associated periodic SL-PRS process from a peer WTRU.

As shown in FIG. 8, WTRU1 and WTRU2 at first select two associated periodic SL-PRS processes, in which WTRU1 selects the type 2 SL-PRS process and WTRU2 selects a type 1 SL-PRS process. WTRU1 performs resource reselection and changes to the type 4 SL-PRS process. WTRU2 detects the change in the periodic SL-PRS process from WTRU1 and triggers resource selection to change to the type 3 SL-PRS process to align with the type 4 SL-PRS process from WTRU1.

A WTRU may determine whether to transmit SL-PRS in a reserved resource. In an embodiment, the WTRU may reserve a periodic resource for SL-PRS transmission. The WTRU may receive an indication of a periodic resource for SL-PRS transmission by another node (e.g. another WTRU). The WTRU may determine whether to perform SL-PRS transmission in one or more reserved/indicated resource based on one or any combination of the following.

The WTRU may determine whether to perform SL-PRS transmission in one or more reserved/indicated resources based on the reception status of one or more previous SL-PRS resources. For example, for a RTT-based method, in one SL-PRS transmission/reception period, the WTRU may determine whether to transmit SL-PRS based on whether it receives SL-PRS correctly in one or more previous SL-PRS resources from a peer WTRU. If the WTRU does not receive one or more SL-PRS correctly from the peer WTRU, it may not transmit SL-PRS. Otherwise, if the WTRU receives a SL-PRS from the peer WTRU correctly, it may transmit in the reserved SL-PRS resource.

The WTRU may determine whether to perform SL-PRS transmission in one or more reserved/indicated resources based on the measurement reporting status of one or more previous SL-PRS measurement reporting occasions. In an example, the WTRU may expect to receive one SL-PRS measurement reporting per one or more SL-PRS transmission of the periodic SL-PRS resources. The WTRU may determine not to transmit SL-PRS in a reserved resource if it does not receive SL-PRS measurement reporting from the previous one or more (e.g. N) SL-PRS measurement reporting occasions. The value of N may be (pre-)configured.

A WTRU may determine to release a periodic SL-PRS process. In an embodiment, the WTRU may reserve a periodic SL-PRS process. The WTRU may determine whether to release the SL-PRS process. The WTRU may not perform SL-PRS transmission in the set of reserved resources for SL-PRS transmission. The decision whether to release the SL-PRS process may be based on one or any combination of the following.

The decision whether to release the SL-PRS process may be based on whether the number of transmission periods is greater than a threshold. For example, the WTRU may determine to perform SL-PRS transmission in N periods. The value of N may be indicated from another node (e.g. another WTRU or gNB). The WTRU may release the periodic resources for SL-PRS transmission if the number of SL-PRS periods is greater than N.

The decision whether to release the SL-PRS process may be based on a reception status of one or more previous SL-PRS resources. For example, for a RTT-based method, the WTRU may determine to release a periodic SL-PRS process if it has not received correctly N (e.g. consecutive N) expected SL-PRS transmissions from a peer WTRU. The value of N may be (pre-)configured.

The decision whether to release the SL-PRS process may be based on the SL-PRS measurement reporting status of one or more previous periods. In an example, for a RTT-based method, in each period, a WTRU (e.g. target WTRU) may perform SL-PRS transmission. The WTRU may receive a SL-PRS and SL-PRS measurement reporting from the peer WTRU (e.g. anchor WTRU). The WTRU may determine whether to release the periodic SL-PRS process if it does not receive SL-PRS measurement reporting from another WTRU (e.g. the peer WTRU) in the past one or more SL-PRS measurement reporting periods. Otherwise, the WTRU may perform SL-PRS transmission in the reserved resource. In an example, for a SL-PRS transmission-based method, the WTRU (e.g. target WTRU) may perform SL-PRS transmission and it may expect to receive SL-PRS measurement reporting from the peer WTRU. The WTRU may determine whether to transmit SL-PRS in one reserved resource based on whether it receives SL-PRS measurement reporting from another WTRU (e.g. the peer WTRU) in the past one or more SL-PRS measurement reporting periods. If the WTRU does not receive SL-PRS measurement reporting in the past one or more SL-PRS measurement reporting periods from the peer WTRU, the WTRU may not perform SL-PRS transmission in the reserved resource. Otherwise, the WTRU may perform SL-PRS transmission in the reserved resource.

The WTRU may perform one or any combination of the following upon releasing the periodic SL-PRS process: send an indication to another node (e.g. another WTRU or gNB), reselect another SL-PRS resource(s), which may be periodic or aperiodic, and terminate the positioning session.

A WTRU may use the SL-PRS reception timing as the reference for SL-PRS transmission timing. In a RTT-based method, the WTRU may perform SL-PRS reception and SL-PRS transmission. The WTRU may use the SL-PRS reception timing as the reference for SL-PRS transmission timing. The WTRU may indicate to a peer WTRU (e.g. in a SCI, MAC CE, PC5 RRC, and/or NAS) that the SL-PRS reception timing of the peer WTRU is used for SL-PRS transmission. The WTRU may then not perform SL-PRS measurement reporting (e.g. Tx-Rx timing measurement). For example, the WTRU may indicate in the SCI (e.g. 1st or 2nd SCI) such an indication.

A WTRU may determine which WTRU (including itself) to initiate a SL-PRS resource selection procedure. A WTRU may determine which WTRU (including itself) to initiate a SL-PR resource selection procedure based on one or any combination of the following. A WTRU may determine which WTRU (including itself) to initiate a SL-PR resource selection procedure based on the initiator of the positioning session. In an example, a target WTRU may initiate a positioning session to locate its position. The target WTRU may initiate the SL-PRS resource procedure first. The WTRU may indicate its resource selection result to the remaining WTRUs in the group. The remaining WTRUs in the group may perform resource allocation based on the selected SL-PRS resource from the resource allocation initiator. In an example, an anchor WTRU may initiate a positioning session to locate the position of one or more target WTRUs. The anchor WTRU may initiate its resource allocation procedure and select SL-PRS resources. Other WTRUs in the group (e.g. target WTRUs) may perform resource selection based on the selected SL-PRS resource from the anchor WTRU. A WTRU may determine which WTRU (including itself) to initiate a SL-PRS resource selection procedure based on the indicator from another node (e.g. LMF). For example, the network (e.g. LMF) may request one WTRU in the positioning group to perform resource allocation. Other WTRUs may perform resource selection for SL-PRS based on the initiator of the SL-PRS procedure.

A WTRU may perform resource selection for SL-PRS based on a reserved SL-PRS of another WTRU. A WTRU may coordinate a resource allocation procedure among WTRUs in a positioning group. For example, a WTRU may determine one or any combination of the following resource allocation parameters. The WTRU may determine the bandwidth, SL-PRS pattern (comb size, offset), and the number of repetitions. The WTRU may determine the SL-PRS periodicity. For example, the WTRU may select the same SL-PRS periodicity as the one selected by the initiator WTRU. The WTRU may determine the resource selection window of the first SL-PRS and/or the first set of SL-PRS resources, which may include the first SL-PRS and its repetitions in one SL-PRS period. For example, the resource selection window of the follower WTRU may be selected based on one or any combination of the following. The resource selection window of the follower WTRU may be selected based on the number of WTRUs in the group. For example, the WTRU may select a larger resource selection window for a group with a higher number of group members. The resource selection window of the follower WTRU may be selected based on the mobility of the WTRUs in the group. For example, the WTRU may be (pre-)configured with two resource allocation window ranges in which the first range may be used if the WTRU's speed is larger than a (pre-)configured threshold, and the second resource allocation window range may be used if the WTRU's speed is smaller than the threshold. The resource selection window of the follower WTRU may be selected based on a QoS of the positioning service. For example, the WTRU may be configured with multiple ranges of the resource selection window, in which each range may be associated with one QoS requirement of the positioning service (e.g. accuracy requirement). The WTRU may determine which resource allocation window to use based on the QoS requirement of the positioning service. Such parameters may be determined based on the selected SL-PRS resources from the initiator the resource allocation procedure in the group.

A WTRU may request another WTRU to stop transmission in a reserved resource. A WTRU (e.g. the initiator of the SL-PRS resource allocation procedure) may request another WTRU to stop transmission of one or more reserved SL-PRS resources. The WTRU may request the WTRU to change the SL-PRS configuration or continue using the periodic SL-PRS process. Such decision may be determined based on whether the reserved resources semi-persistently conflict with another periodic SL-PRS resource from another WTRU. For example, if the two periodic SL-PRS processes are semi-persistently conflicted, the WTRU may request one of the two WTRUs to change the SL-PRS configuration (e.g. change the offset). Otherwise, the WTRU may request one of the two WTRUs to stop transmission in the current period.

A WTRU may determine which SL-PRS(s) to perform pre-emption. In an embodiment, a WTRU (e.g. target WTRU) may reserve a periodic SL-PRS process. For each SL-PRS period, the WTRU may determine whether to perform pre-emption checking and reselect the reserved resource if a conflict is detected. The WTRU may determine the frequency of pre-emption checking and which SL-PRS resource to perform pre-emption (e.g. checking the conflict and reselect the resource if conflict is detected) based on one or any combination of the following. The WTRU may determine the frequency of pre-emption checking and which SL-PRS resource to perform pre-emption based on whether the SL-PRS resource is within the MG/PPW of a peer WTRU. In an example, if the reserved SL-PRS resource is within the MG/PPW of the peer WTRU, the WTRU may perform pre-emption checking, otherwise, if the reserved SL-PRS resource is outside of the peer WTRU's MG/PPW, the WTRU may not perform pre-emption. This approach may be motivated to help the peer WTRU have the best resource to perform measurements. In an example, if the reserved SL-PRS resource is within the MG/PPW of the peer WTRU, the WTRU may not perform pre-emption checking, otherwise, if the reserved SL-PRS resource is outside of the peer WTRU's MG/PPW, the WTRU may perform pre-emption. This approach may be motivated to help the peer WTRU have a SL-PRS resource to measure. The WTRU may determine the frequency of pre-emption checking and which SL-PRS resource to perform pre-emption based on periodic pre-emption checking. For example, the WTRU may be required to perform pre-emption checking at least before a (pre-)configured number of SL-PRS periods, a (pre-)configured number of MG/PPW, and/or a (pre-)configured number of SL-PRS measurement reporting periods. The WTRU may determine the frequency of pre-emption checking and which SL-PRS resource to perform pre-emption based on a CBR of the resource pool. For example, the WTRU may determine to perform pre-emption if a CBR of the resource pool is larger than a threshold, otherwise, if the CBR of the resource pool is smaller than the threshold, the WTRU may skip performing pre-emption. The WTRU may determine the frequency of pre-emption checking and which SL-PRS resource to perform pre-emption based on a QoS of the positioning service. For example, the WTRU may perform pre-emption if accuracy requirement of the positioning service is larger than a threshold, otherwise, the WTRU may skip performing pre-emption.

A WTRU may determine the resource (re-)selection window for a SL-PRS resource. In an embodiment, the WTRU may determine the resource selection window for SL-PRS based on a (pre-)configured MG/PPW of the peer WTRU. For example, the WTRU may (re-)select a SL-PRS resource to be within the MG/PPW window of the per WTRU. In an embodiment, the WTRU may determine the resource selection window for SL-PRS based on the QoS of the positioning service (e.g. latency). The WTRU may indicate to the peer WTRU regarding the selected resource and it may request the peer WTRU to change its MG/PPW configuration according to the newly selected SL-PRS resource.

A WTRU may perform an action after a collision detection. The WTRU may perform pre-emption checking for one or more SL-PRS resources. The WTRU may detect a conflict for a reserved SL-PRS resource. The WTRU may determine to perform one or any combination of the following for the conflicted resource: performs resource (re)selection and stop using the reserved resource. The WTRU may continue using the periodic SL-PRS process after it stops using one or more conflict resources. For example, the WTRU may stop using the reserved resource if its reserved resource is within the MG/PPW of another WTRU.

The WTRU may determine which procedure to follow (e.g. perform resource (re)selection or stop using the reserved resource) based on one or any combination of the following. The WTRU may determine which procedure to follow based on a number of reserved resources within a period (e.g. a measurement reporting window, MG/PPW window). For example, the WTRU may (re)select a reserved resource if the number of reserved resources within a window is smaller than a threshold, otherwise, if the number of reserved resources is larger than the threshold, the WTRU may stop using the reserved resource. The WTRU may determine which procedure to follow based on the MG/PPW length. For example, the WTRU may drop the reserved resource if the MG/PPW is smaller than a threshold, otherwise, if the MG/PPW is larger than a threshold, the WTRU may reselect another resource. The WTRU may determine which procedure to follow based on a QoS (e.g. accuracy) requirement of the positioning service. For example, the WTRU may reselect another resource due to a collision detection if the accuracy of the positioning service is larger than a threshold, otherwise, if the accuracy requirement of the positioning service is smaller than the threshold, the WTRU may stop using the reserved resource without reselecting another resource.

A WTRU may determine a channel busy ratio (CBR) measurement in a dedicated resource pool. In an embodiment, a WTRU may determine the CBR of a resource pool, which may be dedicated for SL-PRS transmission. The CBR may be determined based on the CBR in each slot and/or SL-PRS duration over a measurement window. For example, the CBR in the resource pool may be an average CBR of all slots/SL-PRS duration in the measurement window. The WTRU may determine the CBR in each slot and/or SL-PRS duration based on one or any combination of the following. The WTRU may determine the CBR in each slot and/or SL-PRS duration based on a number of occupied SL-PRS patterns over the number of (pre-)configured SL-PRS patterns in each subchannel and/or in the bandwidth of the resource pool. For example, the WTRU may determine the number of available SL-PRS patterns based on SCI decoding. The WTRU may determine the CBR in each slot as a function of the number of occupied SL-PRS patterns over the number of (pre-)configured patterns. The WTRU may determine the CBR in each slot and/or SL-PRS duration based on a received signal strength indicator (RSSI) measured in the bandwidth of the subchannel or resource pool per SL-PRS duration and/or slot. For example, the WTRU may be (pre-)configured with multiple SL-PRS resources in the time domain per sidelink slot. The WTRU may determine the availability of one resource in the time domain of a subchannel or resource pool based on the measured RSSI. If the measured RSSI of the SL-PRS resource in the time domain of one subchannel or resource pool bandwidth is greater than a threshold, the WTRU may consider the resource as occupied, otherwise, the WTRU may consider the resource as unoccupied. The WTRU may determine the CBR in each slot and/or SL-PRS duration based on the number of occupied PSCCH resources over the number of (pre-)configured PSCCH resources in the CBR measurement window. In an example, the WTRU may determine whether a PSCCH resource is occupied based on a RSRP/RSSI measurement of the resource (pre-)configured for PSCCH. If the RSRP/RSSI in the resource (pre-)configured for PSCCH is greater than a threshold, the WTRU may consider the resource as occupied, otherwise, the WTRU may determine the resource as unoccupied. In an example, the WTRU may determine whether a PSCCH resource is occupied based on the detection of an SCI in the (pre-)configured resource. If the WTRU detects an SCI in the (pre-)configured PSCCH, the WTRU may consider the resource as occupied, otherwise, the WTRU may consider the resource as unoccupied.

The CBR calculation in a period may be determined based on one or any combination of the following. The CBR calculation in a period may be determined based on a selected SL-PRS pattern of the WTRU, which may include the comb size, bandwidth, and/or the number of repetitions (e.g., in a slot). The CBR calculation in a period may be determined based on a multiplexing scheme used for SL-PRS transmission. For example, if the WTRU determines to perform SL-PRS transmission without multiplexing with another transmission at the same time-frequency resource, the CBR in one SL-PRS duration and/or slot may be determined as a binary value, in which the slot/SL-PRS duration may be considered as occupied if there is one SL-PRS pattern transmitted in the slot/SL-PRS duration. Otherwise, the slot may be considered as unoccupied. For example, if the WTRU determines to select one SL-PRS pattern in the set of SL-PRS patterns in a SL-PRS duration, the WTRU may allow multiplexing with another SL-PRS pattern. The CBR in one SL-PRS pattern and/or slot may be determined as a function of the number of occupied patterns over the (pre-)configured patterns for simultaneous transmission at the same time-frequency resource. The CBR calculation in a period may be determined based on the SL-PRS pattern configuration in the resource pool. The CBR calculation in a period may be determined based on the bandwidth of SL-PRS transmission. For example, the granularity of a CBR calculation in a frequency domain may be determined based on the bandwidth of SL-PRS transmission. If the WTRU uses the whole bandwidth of the resource pool for SL-PRS transmission, the WTRU may use the whole resource pool bandwidth as the granularity of CBR calculation in the frequency domain. Otherwise, if the WTRU uses the subchannel-based transmission for SL-PRS, the WTRU may use the bandwidth of a subchannel as the granularity in the frequency domain of CBR calculation.

A WTRU may determine a channel occupancy ratio (CR) for SL-PRS transmission. The WTRU may determine the CR for SL-PRS as a function of the number of occupied resources over the number of configured resources in a CR calculation window.

The WTRU may use the one or any combination of the following as the granularity of a resource for CR calculation in the frequency domain. The WTRU may use a resource element (RE). For example, the WTRU may calculate CR as the ratio between the number of occupied REs and the number of (pre-)configured REs in the CR calculation window. The WTRU may use a SL-PRS pattern. For example, the WTRU may calculate CR as the ratio between the number of occupied SL-PRS patterns and the number of (pre-)configured SL-PRS patterns in the CR calculation window. The WTRU may use a subchannel. For example, the WTRU may calculate CR as the ratio between the number of occupied subchannels and the number of (pre-)configured subchannels in the CR calculation window.

The WTRU may use one or any combination of the following as the granularity of a resource for CR calculation in the time domain. The WTRU may use a symbol. For example, the WTRU may calculate CR as the ratio between the number of occupied symbols and the number of (pre-)configured symbols for SL-PRS transmission in the CR calculation window. The WTRU may use a SL-PRS resource duration in the time domain. For example, the WTRU may calculate CR as the ratio between the number of occupied SL-PRS resource periods and the number of (pre-)configured SL-PRS resource periods in the CR calculation window. The WTRU may use a slot. For example, the WTRU may calculate CR as the ratio between the number of occupied slot and the number of (pre-)configured slots in the CR calculation window.

A WTRU may determine a channel occupancy in a shared resource pool. In an embodiment, the WTRU may maintain one or any combination of the following channel occupancy ratios in a shared resource pool between sidelink communication and SL-PRS: a channel occupancy ratio (CR) for SL-PRS transmission, a CR for sidelink data transmission, or a CR for both SL-PRS and sidelink data transmission.

A WTRU may determine the transmission parameters for SL-PRS. In an embodiment, the WTRU may determine one or any combination of the following transmission parameters for SL-PRS: SL-PRS pattern, which may include the transmission bandwidth, comb size, the number of symbols, and the number of repetition; a periodicity; a transmission power; a number of retransmissions for each SL-PRS in a period; and a multiplexing type with other transmission.

One or any combination of the transmission parameters of SL-PRS may be determined based on one or any combination of the following: a CBR of the resource pool; a CR of the WTRU, which may include CR for SL-PRS transmission, CR for sidelink data transmission and/or CR for both SL-PRS and sidelink data transmission; or one or more QoS parameters of the sidelink positioning service. For example, the WTRU may be (pre-)configured with one set of transmission parameters for each QoS parameter of the sidelink positioning service. For example, the WTRU may be (pre-)configured with the accuracy/priority of the positioning service with one set of transmission parameters (e.g., comb size, transmission bandwidth, and transmission power of SL-PRS). The WTRU may be (pre-)configured with the latency of the positioning service with another set of transmission parameters (e.g., the number of retransmissions, the periodicity). The WTRU may be (pre-)configured the reliability/availability of the sidelink positioning service with another set of transmission parameters. The WTRU may determine the transmission parameter of the SL-PRS based on the QoS parameters of the WTRU.

A WTRU may determine the transmission parameters for a transmission in a resource. In an embodiment, the WTRU may determine one or more transmission parameters in a transmission resource. Such determination may be based on whether the resource is used for standalone SL-PRS, SL-PRS multiplexing with sidelink data, or sidelink data only. In an example, the WTRU may be (pre-)configured with two sets of transmission (Tx) parameters, in which the first set of Tx parameters (e.g., Tx power, transmission bandwidth, MCS, number of retransmission for one TB, etc.) may be associated with sidelink data transmission and the second set of Tx parameters (e.g., Tx power, SL-PRS pattern, bandwidth, comb size, number of symbols for SL-PRS, number of repetitions) may be associated with SL-PRS transmission. Each set of parameters may be further (pre-)configured as a function of the CBR of the resource pool, CR of the WTRU (e.g., CR for SL-PRS transmission, CR for sidelink data transmission, and/or CR for both SL-PRS and sidelink data transmission), QoS of the data transmission, and/or QoS associated with sidelink positioning service. The WTRU may determine the Tx parameters for each transmission in a resource pool based on whether the resource is used for standalone SL-PRS, SL-PRS multiplexing with sidelink data, or sidelink data only. For example, if the WTRU uses the resource for standalone SL-PRS, the WTRU may use the second set of Tx parameters as a function of CBR of the resource pool, CR of the WTRU, and QoS of the sidelink positioning service. If the WTRU uses the resource for SL-PRS and sidelink data, the WTRU may determine the transmissions parameters based on both the first and the second set of transmission parameters.

A WTRU may determine whether to drop a SL-PRS resource. In an embodiment, the WTRU may be indicated or select a resource for SL-PRS transmission. The WTRU may determine whether to perform SL-PRS transmission in the resource based on one or any combination of the following: a CR for SL-PRS and/or a CR for SL-PRS and sidelink data, or whether the resource belongs to a muting pattern of the WTRU. For example, the WTRU may determine the muting pattern for a periodic SL-PRS transmission. The WTRU may implicitly/explicitly indicate its muting pattern in one or more transmissions associated with the SL-PRS. The WTRU may determine to transmit SL-PRS in the resource if the resource is not within the muting pattern of the WTRU.

A WTRU may determine the availability of a subchannel slot based on the type of transmission in the subchannel-slot. In an embodiment, the WTRU may determine the availability of one subchannel-slot based on the type of transmission detected in the subchannel-slot. For example, the WTRU may be (pre-)configured with multiple RSSI thresholds. Each RSSI threshold may be associated with one type of subchannel-slot. For example, the WTRU may be (pre-)configured with three RSSI thresholds, in which the first RSSI threshold may be used for sidelink data transmission, the second threshold may be used for sidelink data transmission with SL-PRS, and the third RSSI threshold may be used for standalone SL-PRS. The WTRU may also use one of the three RSSI thresholds (e.g. the third RSSI threshold), for undetected sidelink transmission in the subchannel-slot. The WTRU may determine each type of transmission in a subchannel-slot by an indication of a transmission associated with the transmission in the subchannel-slot (e.g. in the SCI). The WTRU may use an associated RSSI threshold to determine the availability of each subchannel-slot to calculate CBR in a CBR measurement window.

A WTRU may calculate multiple CBRs for each type of transmission. A WTRU may determine to calculate multiple CBRs, in which each CBR may be associated with a CBR occupied by one type of transmission. For example, the WTRU may calculate CBR due to transmission of standalone SL-PRS, CBR due to transmission of sidelink data, CBR due to transmission of sidelink data with SL-PRS, CBR due to undetected transmissions, and/or CBR due to all type of sidelink transmissions.

A WTRU may calculate multiple channel occupancy ratio (CRs). A WTRU may determine to calculate multiple CRs, in which each CR may be associated with a channel busy ratio occupied by one type of transmission. For example, the WTRU may calculate CR for transmission of standalone SL-PRS, CR for transmission of sidelink data, CR for transmission of sidelink data with SL-PRS, and/or CR for all type of sidelink transmissions.

A WTRU may calculate multiple CBRs using multiple RSSI thresholds. A WTRU may be (pre-)configured with multiple RSSI thresholds to determine the availability of one subchannel-slot (e.g. the availability of one subchannel in one slot) in a CBR measurement. The WTRU may calculate multiple CBRs in which each CBR may be associated with one RSSI threshold. For example, for each RSSI threshold, the WTRU may determine the ratio between the number of busy subchannel-slots and the total number of subchannel-slots in a CBR measurement window, in which the channel-slot may be considered busy if the measured RSSI in that subchannel-slot is greater than the RSSI threshold. For example, the WTRU may be (pre-)configured with two RSSI thresholds, in which one RSSI threshold (e.g. a low RSSI threshold) may be used to consider SL-PRS transmissions. The WTRU may be (pre-)configured with another RSSI threshold (e.g. a high RSSI threshold), which may be used to catch the normal to calculate sidelink data transmission.

A WTRU may use two CBRs to adjust its sidelink transmission. In an embodiment, the WTRU may use a CBR associated with a first RSSI threshold (e.g. first CBR) to adjust one or more transmission parameters associated with SL-PRS (e.g. standalone SL-PRS and/or SL-PRS with data). The WTRU may use a CBR associated with a second RSSI threshold (e.g. second CBR) to adjust one or more transmission parameters associated with sidelink data transmission (e.g. sidelink data only and/or SL-PRS with sidelink data). For example, the WTRU may be (pre-)configured with the range of SL-PRS transmission parameters (e.g. Tx power, SL-PRS pattern, bandwidth, comb size, number of symbols for SL-PRS, number of repetitions) for each range of the first CBR. The WTRU may determine which transmission parameters to use based on whether the first CBR belongs to which range. For example, the WTRU may be (pre-)configured with the range of data transmission parameters (e.g. Tx power, transmission bandwidth, MCS, number of retransmission for one TB, etc.) for each range of the second CBR. The WTRU may determine which sidelink data transmission parameters to use based on whether the second CBR belongs to which range.

A WTRU may adjust transmission parameters of a SL-PRS if a CR is greater than a threshold. A WTRU may determine to adjust a transmission parameter of a SL-PRS if a CR is greater than a (pre-)configured threshold. For example, the WTRU may increase a comb size, reduce the SL-PRS duration, and/or reduce SL-PRS transmission bandwidth if the CR is greater than the (pre-)configured threshold. In an example, the WTRU may be (pre-)configured with a CR limit for standalone SL-PRS transmission. The WTRU may additionally multiplex SL-PRS with data if the CR for standalone SL-PRS is larger than a threshold.

A WTRU may determine which measurement parameter(s) to request. In an embodiment, a WTRU (e.g., target WTRU) may request another WTRU (e.g., anchor WTRU) to report one or more SL-PRS measurement parameters. The requested WTRU may perform a SL-PRS measurement and report the set of measurement parameters based on the indicated/requested SL-PRS measurement parameters from the requester WTRU. In an embodiment, a WTRU (e.g., anchor WTRU) may autonomously determine one or more SL-PRS measurement parameters to perform a measurement and report to another node (e.g. gNB, LMF, another WTRU such as target WTRU, anchor WTRU). The SL-PRS measurement parameters may include, for example, a SL-reference signal receive power (RSRP), Reference Signal Received Path Power (SL-RSRPP), transmission and reception time difference (Tx-Rx difference), reference signal time difference (RSTD), time of departure (ToD), angle of departure (AoD), time of arrival (ToA), Timing Error Group (TEG), phase of arrival (PoA), phase of departure (PoD), difference phase of arrival (DPoA), and difference phase of departure (DPoD).

A WTRU may determine which measurement parameter or parameters to request. A WTRU (e.g., target WTRU) may determine which SL-PRS measurement parameters to report/request based on one or any combination of the following. The WTRU may determine which SL-PRS measurement parameters to report/request based on a positioning method. For example, for a RTT method, the WTRU may report/request the Tx-Rx difference and SL-RSRP of the SL-PRS. For a SL-TDOA method, the WTRU may request/report RSTD, ToA, and/or SL-RSRP. The WTRU may determine which SL-PRS measurement parameter to report/request based on the Rx WTRU's capability. For example, the Tx WTRU may request the Rx WTRU to report the SL-RSRPP and LOS/NLOS (Line-of-sight/Non-line-of-sight) condition based on the Rx WTRU's capability. For example, the Rx WTRU may indicate its SL-PRS measurement capability. The Tx WTRU may request the Rx WTRU to report a certain SL-PRS measurement parameter based on the Rx WTRU's capability. The WTRU may determine which SL-PRS measurement parameters to report/request based on a QoS (e.g. priority, accuracy, latency, positioning availability) of the positioning service. For example, the WTRU may request/report a certain parameter if a QoS (e.g. accuracy) of the positioning service is greater than a threshold. For example, the WTRU may request/report a LOS/NLOS condition indication if the accuracy requirement of the positioning service is greater than a threshold, otherwise, the WTRU may not be allowed to request the Rx WTRU to measure and report LOS/NLOS condition. The WTRU may determine which SL-PRS measurement parameters to report/request based on the quality of one reported SL-PRS measurements. For example, the anchor WTRU may report SL-RSRP and RSTD, in which the reported SL-RSRP is smaller than a configured threshold. The target WTRU may request the anchor WTRU to additionally report LOS/NLOS condition to help the anchor WTRU determine whether the calculated distance between two WTRUs is based on the LOS or NLOS condition.

A WTRU may report a quality indicator for a measurement. A WTRU (e.g. anchor WTRU) may determine and report a quality indicator of one or more SL-PRS measurement parameters. For example, the WTRU may report/indicate, for example implicitly, the quality of its measurement. The quality indicator may indicate whether the WTRU experiences much fluctuation in the power and time measurement. It also may indicate the variant in the measurement, in which the WTRU may indicate the error bound of a certain SL-PRS measurement parameter. For example, the WTRU may indicate the measured value of a SL-RSRP. The WTRU may indicate the error bound of the measured SL-RSRP. The WTRU may trigger reporting the quality indicator of one or more SL-PRS measurement parameters based on one or any combination of the following: an indication from another node and whether the quality indicator is smaller/larger than a threshold or the error bound is larger/smaller than a threshold. For example, the WTRU (e.g., anchor WTRU) may report the quality indicator if the error bound is larger than a (pre-)configured threshold. For example, the WTRU may report the quality indicator if the quality indicator is larger than a (pre-)configured threshold, which may implicitly indicate that the measurement is good, and the target WTRU may use such report to derive its distance. This approach may be motivated to support the target WTRU in determining which report to use in calculating its distance.

A WTRU may perform an action upon reception of a quality indicator for a measurement. In an embodiment, a WTRU (e.g. target WTRU) may be (pre-)configured with one or more thresholds for a quality indicator of a SL-PRS measurement parameter. The WTRU may perform a first action if the quality indicator is greater than a first threshold and the WTRU may perform a second action if the quality indicator is smaller than a second threshold. The high value of a quality indicator may correspond to a good measurement. The first and second thresholds may be the same or different. The first action may be selecting a reported measurement to forward to the network (e.g. LMF). The second action may belong to one or more of the following: remove the report from the set of measurement reporting to the network (e.g. LMF); trigger resource selection for SL-PRS to transmit more SL-PRS to the reporting WTRU; transmit more SL-PRS to the WTRU; change the SL-PRS configuration (e.g. add more SL-PRS resources, increase transmission power, increase SL-PRS bandwidth, reduce a SL-PRS comb size, and/or increase a SL-PRS duration); and remove the WTRU (e.g. anchor WTRU) from the positioning group.

A WTRU may determine a measurement report granularity of a measurement parameter. A WTRU (e.g. anchor WTRU) may determine the granularity of one or more (e.g. each) measurement parameter to report to another node (e.g. target WTRU, LMF, gNB). In the report, the WTRU may indicate which granularity is used to report a SL-PRS measurement parameter. The WTRU may determine the granularity of each measurement parameter based on one or any combination of the following. The WTRU may determine the granularity of each measurement parameter based on an indication from another node (e.g., target WTRU, gNB, LMF). For example, the target WTRU may indicate to the anchor WTRU the granularity of one or more SL-PRS measurement parameters (e.g. ToA, RSTD, Tx-Rx). The anchor WTRU may use the granularity indicated by the target WTRU to perform SL-PRS measurement and reporting. The WTRU may determine the granularity of each measurement parameter based on a positioning method. For example, for one SL-PRS measurement parameter, the WTRU may be (pre-)configured with one granularity per positioning method. The WTRU may determine which granularity to use to perform a measurement and report based on the positioning method the WTRU is using. For example, for SL-RSRP measurement and reporting, the WTRU may be (pre-)configured with one granularity for an angle-based method (e.g. AoA, AoD) and another granularity for a timing-based method (SL-TDOA, RTT). The WTRU may determine which granularity to use based on the used positioning method. The WTRU may determine the granularity of each measurement parameter based on a QoS (e.g. priority, accuracy, latency, positioning availability) of the positioning service. For example, the WTRU may be (pre-)configured with multiple granularities of a SL-PRS measurement parameter. Each granularity may be associated with a positioning accuracy requirement. The WTRU may determine which granularity to use based on the positioning accuracy requirement of the positioning service. The WTRU may determine the granularity of each measurement parameter based on a distance between a SL-PRS transmitter (e.g. target WTRU) and SL-PRS receiver (e.g. anchor WTRU). For example, the WTRU may be (pre-)configured with multiple granularities, in which each granularity may be associated with a range of distance between the a transmitter and receiver. The WTRU may determine which granularity to use for the SL-PRS measurement parameter based on the distance between the SL-PRS transmitter and receiver belongs to which (pre-)configured range. The WTRU may determine the granularity of each measurement parameter based on a propagation time between the transmitter and receiver. For example, the WTRU may be (pre-)configured multiple granularities. Each granularity may be associated with a range of propagation time between the transmitter and receiver. The WTRU may determine which granularity to use for the SL-PRS measurement parameter based on the propagation time between SL-PRS transmitter and receiver belonging to which (pre-)configured range. The WTRU may determine the granularity of each measurement parameter based on a value of the SL-PRS measurement parameters (e.g. RSTD, AoA, AoD, distance, ToA, ToD). For example, the WTRU may be (pre-)configured multiple SL-PRS granularities for a SL-PRS measurement parameter. Each granularity may be used for a range of SL-PRs measurement parameter. The WTRU may determine which granularity to use based on the value of the SL-PRS measurement parameter belonging to which (pre-)configured range.

A WTRU may determine a MG/PPW configuration. In an embodiment, a WTRU (e.g. target WTRU) may determine its MG/PPW configuration (e.g. offset, periodicity, and MG/PPW length) to perform a SL-PRS measurement and SL-PRS measurement processing. The WTRU may determine the MG/PPW configuration based on one or any combination of the following. The WTRU may determine the MG/PPW configuration based on a SL-PRS configuration (e.g. offset, periodicity of SL-PRS). For example, the WTRU may determine to configure a MG/PPW every (pre-)configured number of SL-PRS periods. The WTRU may configure a MG/PPW to be the same as the offset of SL-PRS. The WTRU may determine the MG/PPW configuration based on a SL-PRS measurement reporting configuration. For example, the WTRU (e.g. anchor WTRU) may determine to configure a MG/PPW such that the WTRU may be able to measure a SL-PRS within the MG/PPW for at least a (pre-)configured number of times. The (pre-)configured number of MG/PPW between two reporting may be indicated by another node (e.g. LMF, target WTRU), which may be determined based on the QoS of the positioning service. The WTRU may configure MG/PPW to be the same as the offset of SL-PRS measurement reporting. The WTRU may determine the MG/PPW configuration based on a QoS of the positioning service. For example, the WTRU may determine to configure a longer MG/PPW with a shorter periodicity if the positioning service has high accuracy and/or low latency requirements. The WTRU may determine to configure a shorter MG/PPW with a longer periodicity if the positioning service require low accuracy and/or high latency.

A WTRU may trigger resource (re)selection based on a MG/PPW indicated from a Rx WTRU. In an embodiment, the WTRU (e.g. target WTRU) may trigger resource (re)selection for SL-PRS upon receiving the MG/PPW of a peer WTRU if its reserved SL-PRS resources for the peer WTRU is within the MG/PPW of the peer WTRU. In an example, the WTRU (e.g. target WTRU) may trigger resource (re-)selection for SL-PRS upon receiving MG/PPW configuration for itself (e.g. from another WTRU or from LMF) if its reserved SL-PRS resource is within the configured MG/PPW.

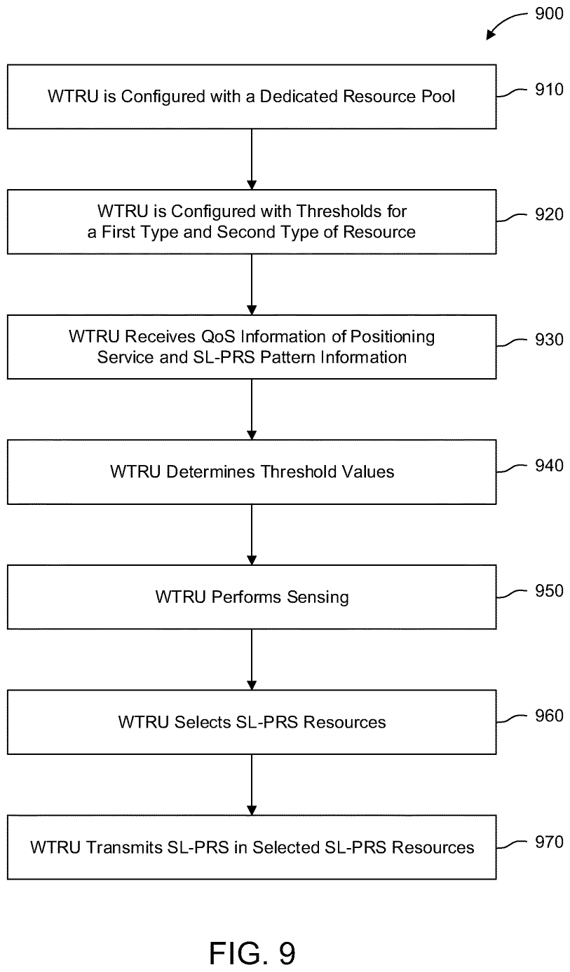

In an embodiment, the WTRU may perform resource allocation in a dedicated resource pool for SL-PRS. The WTRU may determine which set of available resources for SL-PRS transmission to select based on a number of available resources in each set. FIG. 9 shows an example method 900 for resource allocation in a dedicated resource pool for SL-PRS. The WTRU may be (pre-)configured with a dedicated resource pool for SL-PRS transmission 910. The WTRU may receive information indicating a dedicated resource pool for SL-PRS transmission The WTRU may be (pre-)configured with a threshold for a first type of resource and a threshold for a second type of resource to perform SL-PRS selection/transmission 920. For example, the WTRU may receive information indicating a first threshold (e.g. X %) for a first type of resources and a second threshold (e.g. Y %) for a second type of resources. X % and Y % may be a function of the QoS of the positioning service (e.g., priority, accuracy, latency, availability, and/or reliability). The first type of resources may be a first set of resources and the second type of resources may be a second set of resources. For example, the first set of resources may include a set of slots for SL-PRS transmission (e.g. TDM), and the second set of resources may include a set of REs in a slot according to a (pre)configured SL PRS pattern. In a slot, there may be a number of second type of resources. The first type of resources may be resources that are not RE level multiplexed with other WTRUs. The second type of resources may be resource that are RE level multiplexed with other WTRUs. X % may denote the ratio between the number of first type of resources available for resource selection and a total number of the first type of resources. Y % may denote the ratio between the number of second type of resources available for resource selection and a total number of the second type of resources. In an example, the WTRU may determine X % and Y % based on a resource allocation for a non-positioning service (e.g., data communication). For example, the WTRU may receive a priority level of data communication and determine X % and Y % based on the priority level associated with data communication. The WTRU may receive QoS information of the positioning service and a SL-PRS pattern to select, from another node (e.g., anchor WTRU) 930. The WTRU may determine the value of X and Y based on the QoS information received from the other node 940. The WTRU may perform sensing to determine a first and second set of available resources 950. The WTRU may perform sensing by decoding an SCI. The WTRU may acquire resource reservation information indicated in a decoded SCI and perform RSRP measurement of the PSCCH carrying the decoded SCI. In another example, the WTRU may measure a RSRP of the PSSCH associated with the PSCCH. The WTRU may determine a slot may be a first type of resource available for resource selection when either of the following may occur: the WTRU does not decode any SCI including resource reservation for the slot in sensing, or the WTRU decodes a SCI including resource reservation for the slot in sensing and the associated RSRP is below a (pre)configured threshold. The WTRU may determine that a set of REs in a slot according to a (pre)configured SL PRS pattern available for resource selection may be a second type resource when either of the following may occurs: the WTRU does not decode any SCI including resource reservation for the set of REs in the slot, or the WTRU decodes a SCI including resource reservation for the set of REs in the slot in sensing and the associated RSRP is below a (pre)configured threshold. The WTRU may select SL-PRS resources for transmission 960. If the first set of resources (e.g. the number of resources in the first set) is greater than X %, the WTRU may select the SL-PRS resource from the first set. If the first set of resources (e.g. the number of resources in the first set) is equal to or smaller than X % and the first and second set of resources (e.g. the number of resources in the first and second set) is greater than Y %, the WTRU may select the SL-PRS resource from the first and second set. The WTRU may transmit a SL-PRS in the selected resources 970. If the WTRU does not select SL-PRS resources, the WTRU may request the other node (e.g., anchor WTRU) to change the SL-PRS pattern.

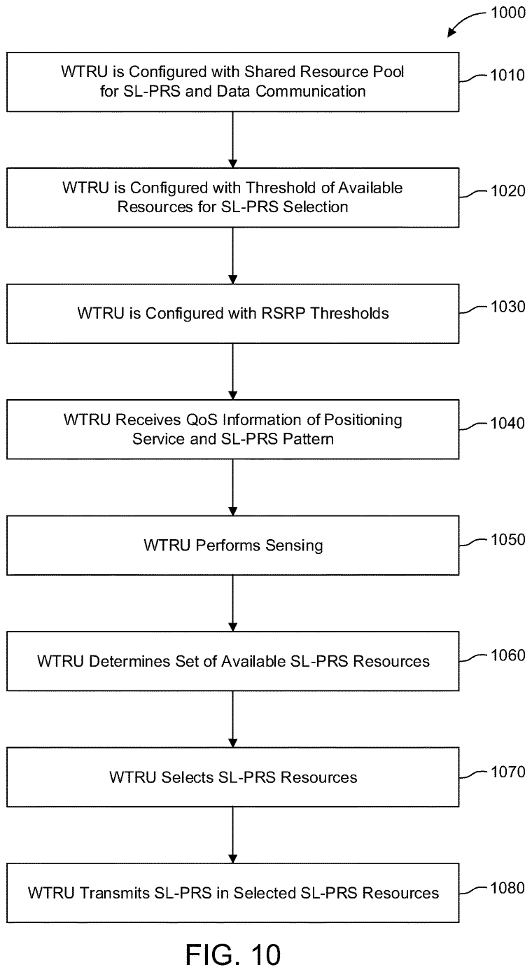

In an embodiment, the WTRU may perform resource allocation in a shared resource pool between SL-PRS and sidelink data. The WTRU may determine which threshold (e.g. RSRP threshold) to apply to determine the availability of each reserved resource based on whether the resource is reserved for a normal data communication or a SL-PRS. If the number of available resources is smaller than a threshold, the WTRU may request another WTRU to change the SL-PRS pattern. FIG. 10 shows an example method 1000 for resource allocation in a shared resource pool between SL-PRS and sidelink data. The WTRU may be (pre-)configured with a shared resource pool for SL-PRS and data communication 1010. The WTRU may receive information indicating the shared resource pool. The WTRU may be (pre-)configured with a threshold (e.g. X %) of available resources for SL-PRS selection 1020. The WTRU may receive information indicating the threshold of X % of available resources for SL-PRS selection. The WTRU may be (pre-)configured with two sets of RSRP thresholds 1030. The WTRU may receive information indicating the sets of RSRP thresholds. One set of RSRP thresholds may be applied for SL-PRS resources and the other set of RSRP thresholds may be applied for data transmission. The WTRU may receive QoS information of the positioning service and a SL-PRS pattern to select, from another node (e.g., anchor WTRU) 1040. The WTRU may perform sensing 1050. The WTRU may perform sensing by decoding an SCI, which may be used to reserve transmission resources, from other WTRUs. For each reserved resource, the WTRU may determine whether the reserved resource is for SL-PRS or normal data communication. The WTRU may determine the set of available resources for SL-PRS transmission 1060. The WTRU may determine the set of available resources for SL-PRS transmission using the first set of RSRP thresholds and the second set of RSRP thresholds. The WTRU may apply the first set of RSRP thresholds to resources associated with SL-PRS. The WTRU may apply the second set of RSRP threshold to resources associated with data communication. The WTRU may select SL-PRS resources 1070. If the number of available resources is greater than X %, the WTRU may select resources for SL-PRS using the available resources and indicating in an SCI that the resource is reserved for SL-PRS transmission. If the number of available resources is not greater than X %, the WTRU may request the other node (e.g., anchor WTRU) to change the SL-PRS pattern or switch to another resource pool for SL-PRS selection. The WTRU may transmit a SL-PRS in the selected SL-PRS resources 1080.

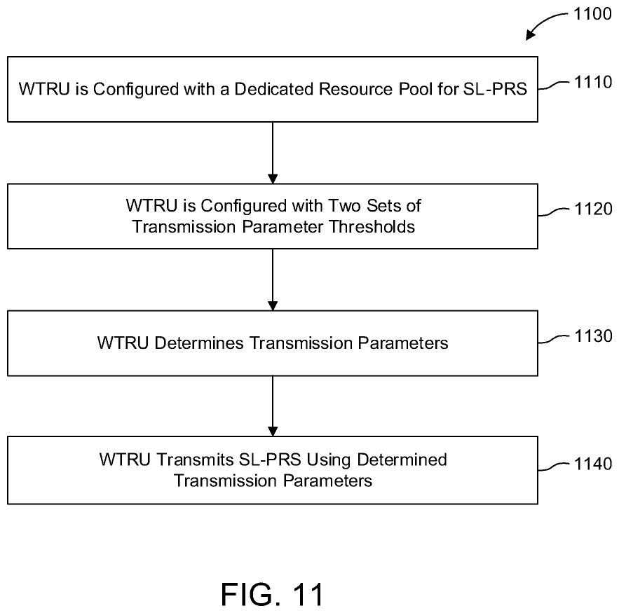

In an embodiment, for congestion control in a dedicated resource pool for SL-PRS, a WTRU may determine a first set of transmission (Tx) parameters for SL-PRS based on a first QoS parameter of the positioning service and a second set of Tx parameters for SL-PRS based on a second QoS parameter. FIG. 11 shows an example method 1100 for congestion control in a dedicated resource pool for SL-PRS. The WTRU may be (pre-)configured with a dedicated resource pool for SL-PRS 1110. The WTRU may receive information that indicates a dedicated resource pool for SL-PRS. The WTRU may be (pre-)configured with two sets of Tx parameter thresholds 1120. The Tx parameter thresholds may be a function of CBR. The WTRU may receive information that indicates two sets of Tx parameter thresholds. The first set of Tx parameter thresholds may be associated with a first positioning QoS parameter. The second set of Tx parameter thresholds may be associated with a second positioning QoS parameter. For example, a maximum bandwidth may be a function of an accuracy/priority requirement and the number of SL-PRS transmissions within a period may be a function of a latency requirement. The WTRU may determine the Tx parameters based on, for example, the QoS parameters, CBR, and the associated Tx parameters thresholds 1130. The WTRU may transmit a SL-PRS based on or using the determined transmission parameters 1140.

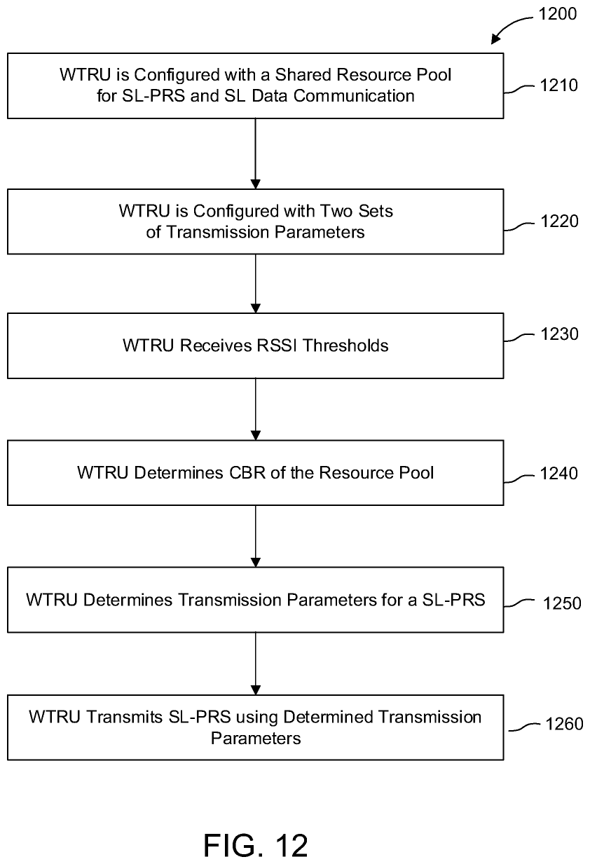

In an embodiment, a WTRU may perform congestion control in a shared resource pool. The WTRU may determine which set of Tx parameters to use based on whether a SL-PRS is multiplexed with data. The WTRU may use a first set of Tx parameters for standalone SL-PRS and both the first and a second set of parameters for SL-PRS multiplexing with data. FIG. 12 show an example method 1200 for congestion control in a shared resource pool between SL-PRS and sidelink data communication. The WTRU may be (pre-)configured with a shared resource pool for SL-PRS and SL data communication 1210. The WTRU may receive information that indicates a shared resource pool for SL-PRS and SL data communication. The WTRU may be (pre-)configured with two sets of transmission (Tx) parameters 1220. The WTRU may receive information that indicates two sets of Tx parameters. The two sets of Tx parameters may be a function of CBR. The first set of Tx parameters may be used for SL-PRS transmission (e.g., Tx power, bandwidth, CR limit for SL-PRS, comb-N, number of symbols, etc.). The second set of TX parameters may be used for data transmission. The WTRU may receive information regarding two RSSI thresholds 1230. In an example, the RSSI thresholds may be (pre)configured in a resource pool. The first RSSI threshold may be used for standalone SL-PRS and the second RSSI threshold may be used for other transmissions, for example, PSSCH/PSCCH transmissions. The WTRU may determine the CBR of the resource pool 1240. If the subchannel slot is transmitted by a standalone SL-PRS, the WTRU may use the first RSSI threshold to determine the availability of the subchannel slot. If the subchannel slot is not transmitted by a standalone SL-PRS, the WTRU may use the second RSSI threshold to determine the availability of a subchannel slot. The WTRU may determine the Tx parameters for a SL-PRS based on whether it is a standalone SL-PRS or a SL-PRS multiplexing with sidelink data 1250. For example, for a standalone SL-PRS, the WTRU may apply the first set of Tx parameters and for SL-PRS multiplexing with sidelink data, the WTRU may determine the Tx parameters based on both the first and the second set of Tx parameters threshold (e.g., each Tx parameters needs to satisfy either threshold in the first or second set). The WTRU may transmit a SL-PRS based on or using the determined transmission parameters 1260.

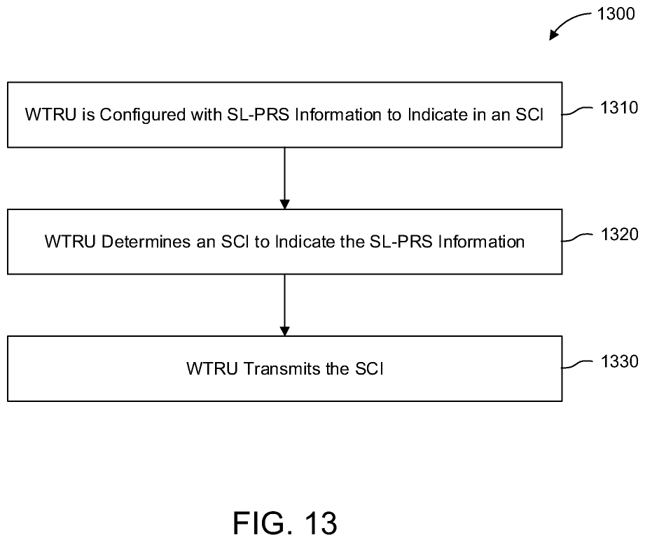

In an embodiment, a WTRU may determine an SCI to indicate SL-PRS information. The WTRU may perform SL-PRS transmission. The WTRU may determine which SCI to indicate information about its SL-PRS transmission based on whether the WTRU transmits a standalone SL-PRS or a SL-PRS with data. FIG. 13 shows an example method 1300 for determining an SCI to indicate SL-PRS information. The WTRU may be (pre-)configured with SL-PRS information to indicate in an SCI 1310. The WTRU may receive information that indicates SL-PRS information to indicate in an SCI. For example, the SL-PRS information may be a SL-PRS pattern (e.g. comb size, RE-offsets, SL-PRS duration). The WTRU may determine which SCI to indicate the SL-PRS information (e.g. SL-PRS pattern) 1320. For example if the WTRU transmits a standalone SL-PRS, the WTRU may use a first SCI (e.g. SCI transmitted in a PSCCH) to indicate the SL-PRS information and if the WTRU transmits a SL-PRS with data, the WTRU may use a second SCI (e.g. SCI transmitted in PSSCH) to indicate the SL-PRS information. The WTRU may transmit the SCI 1330.

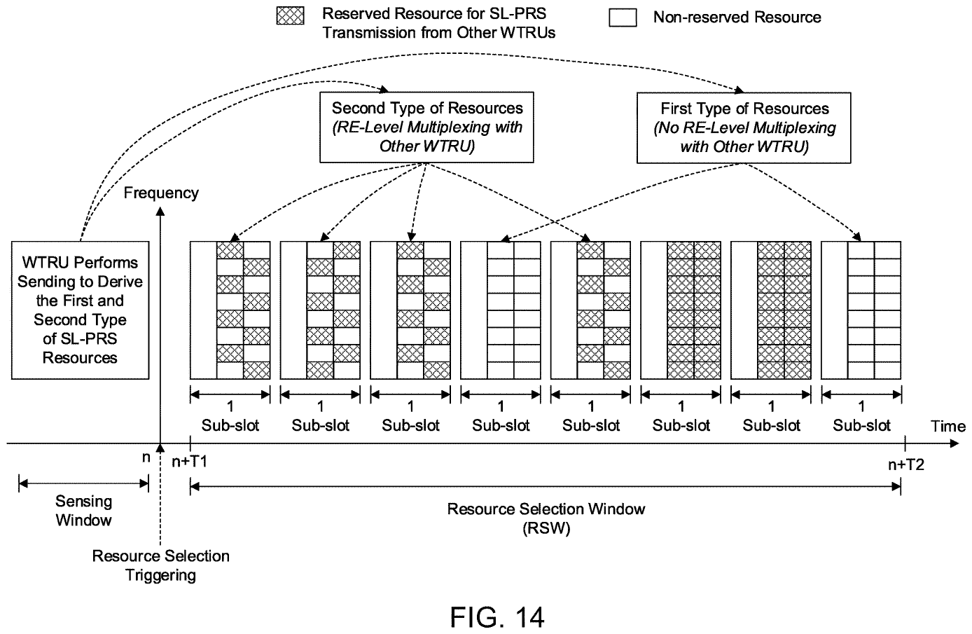

FIG. 14 shows an example of sensing to determine a first and second type of SL-PRS resources. A WTRU may perform sensing, during a sensing window, to determine a first type of resources and a second type of resources. The first type of resources may be resources that are not RE level multiplexed with other WTRUs. The second type of resources may be resources that are RE level multiplexed with other WTRUs. A resource selection trigger may occur, for example at time n. Resources may be selected during a resource selection window (RSW) for example between time n+1 and n+2.

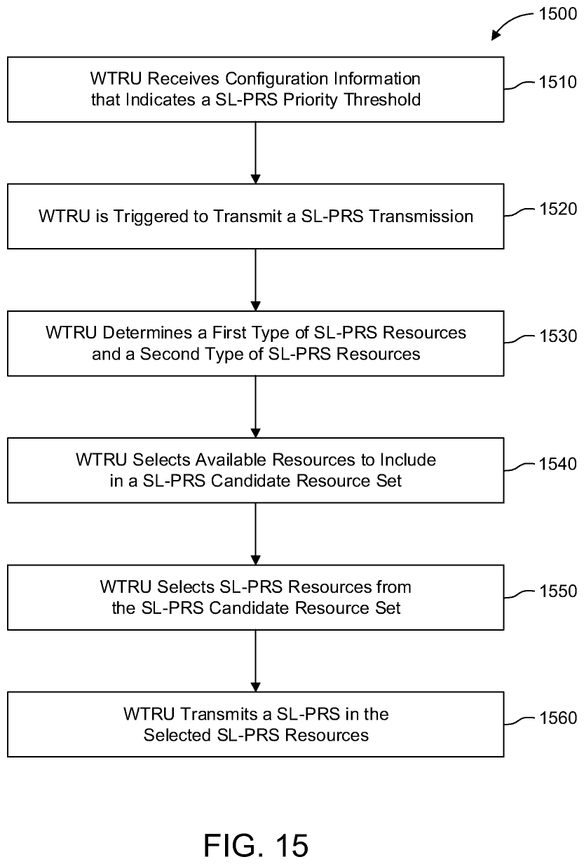

FIG. 15 shows an example method 1500 for determining SL-PRS candidate resource sets based on priority. A WTRU may receive configuration information that indicates a SL-PRS priority threshold 1510. The priority threshold information may be (pre)configured in a SL resource pool. The priority threshold information may be indicated in higher layer signaling (e.g. WTRU-specific signaling). The WTRU may receive information that triggers a SL-PRS transmission 1520. The information that triggers a SL-PRS transmission may be received from a higher layer in the WTRU. The information that triggers a SL-PRS transmission may be received from a non-access stratum (NAS) layer. The triggered SL-PRS transmission may have an associated priority. The priority may be indicated from a higher layer. The WTRU may determine a first type of SL-PRS resources and a second type of SL-PRS resources 1530. The determination may be based on sensing during a sensing window. The sensing may be performed per slot or per sub-slot. The sensing may determine or provide information regarding SL-PRS resources that are reserved by other WTRUs. The first type of SL-PRS resources may be resources that are not multiplexed with other WTRUs. The first type of SL-PRS resources may be resources that are not resource element (RE) level multiplexed with other WTRUs. The second type of SL-PRS resources may be resources that are multiplexed with other WTRUs. The second type of SL-PRS resources may be resources that are resource element (RE) level multiplexed with other WTRUs. The WTRU may select available resources to include in a SL-PRS candidate resource set 1540. The selecting available resources to include in a SL-PRS candidate resource set may be performed during a resource selection window (RSW). The WTRU may select available resources based on the priority associated with the SL-PRS transmission and the SL-PRS priority threshold. The SL-PRS candidate resource set may include at least the first type of SL-PRS resources or the second type of SL-PRS resources. The WTRU may select available resources from both the first type of SL-PRS resources and the second type of SL-PRS resources on a condition that the priority associated with the SL-PRS transmission is lower than the SL-PRS priority threshold. The WTRU may select available resources from only the first type of SL-PRS resources on a condition that the priority associated with the SL-PRS transmission is higher than or equal to the SL-PRS priority threshold. The WTRU may select one or more SL-PRS resources from the SL-PRS candidate resource set 1550. The WTRU may transmit a SL-PRS in the selected one or more SL-PRS resources 1560.

A WTRU that is (pre)configured may also mean that the WTRU receives information regarding a configuration.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1.-20. (canceled)

21. A wireless transmit/receive unit (WTRU) comprising:
a receiver;
a processor; and
a transmitter, wherein:
the receiver is configured to receive sidelink positioning reference signal (SL-PRS) configuration information;
the processor is configured to determine at least one SL-PRS resource for transmitting a SL-PRS; and
the transmitter is configured to transmit the SL-PRS with an indication of the at least one SL-PRS resource in a sidelink control information (SCI), wherein a format of the SCI is based on whether the SL-PRS is a standalone SL-PRS or whether the SL-PRS is transmitted with SL data.

22. The WTRU of claim 21, wherein the format of the SCI is a first stage SCI based on the WTRU transmitting a standalone SL-PRS.

23. The WTRU of claim 22, wherein the transmitter is further configured to transmit the SL-PRS in a physical sidelink control channel (PSCCH).

24. The WTRU of claim 21, wherein the format of the SCI is a second stage SCI based on the WTRU transmitting the SL-PRS with sidelink data.

25. The WTRU of claim 24, wherein the transmitter is further configured to transmit the SL-PRS in a physical sidelink shared channel (PSSCH).

26. The WTRU of claim 24, wherein the second stage SCI comprises an indication of a SL-PRS pattern.

27. The WTRU of claim 24, wherein the second stage SCI is indicated by a bitfield in a first stage SCI.

28. The WTRU of claim 24, wherein the SL-PRS is transmitted in different symbols than the sidelink data.

29. The WTRU of claim 21, wherein the at least one SL-PRS resource comprises at least one of: a SL-PRS resource identification (ID), a comb size, a resource element (RE) offset, a starting symbol of a SL-PRS, or a SL-PRS duration.

30. The WTRU of claim 21, wherein the SL-PRS configuration information comprises at least one of: a dedicated resource pool for SL-PRS transmission or a shared resource pool for SL-PRS transmission and data.

31. A method for use by a wireless transmit/receive unit (WTRU), the method comprising:
receiving sidelink positioning reference signal (SL-PRS) configuration information;
determining at least one SL-PRS resource for transmitting a SL-PRS; and
transmitting the SL-PRS with an indication of the at least one SL-PRS resource in a sidelink control information (SCI), wherein a format of the SCI is based on whether the SL-PRS is a standalone SL-PRS or whether the SL-PRS is transmitted with SL data.

32. The method of claim 31, wherein the format of the SCI is a first stage SCI based on the WTRU transmitting a standalone SL-PRS.

33. The method of claim 32, further comprising transmitting the SL-PRS in a physical sidelink control channel (PSCCH).

34. The method of claim 31, wherein the format of the SCI is a second stage SCI based on the WTRU transmitting the SL-PRS with sidelink data.

35. The method of claim 34, further comprising transmitting the SL-PRS in a physical sidelink shared channel (PSSCH).

36. The method of claim 34, wherein the second stage SCI comprises an indication of a SL-PRS pattern.

37. The method of claim 34, wherein the second stage SCI is indicated by a bitfield in a first stage SCI.

38. The method of claim 34, wherein the SL-PRS is transmitted in different symbols than the sidelink data.

39. The method of claim 31, wherein the at least one SL-PRS resource comprises at least one of: a SL-PRS resource identification (ID), a comb size, a resource element (RE) offset, a starting symbol of a SL-PRS, or a SL-PRS duration.

40. The method of claim 31, wherein the SL-PRS configuration information comprises at least one of: a dedicated resource pool for SL-PRS transmission or a shared resource pool for SL-PRS transmission and data.
